(19) United States
(12) Patent Application Publication
(10) Pub. No.: US 2025/0346470 A1
(43) Pub. Date: Nov. 13, 2025

(54) VEHICLE WITH LIFT ASSEMBLY

(71) Applicant: Oshkosh Corporation, Oshkosh, WI (US)

(72) Inventors: Louis Bafile, Oshkosh, WI (US); Luke Dugan, Oshkosh, WI (US); Matt Becker, Oshkosh, WI (US)

(73) Assignee: Oshkosh Corporation, Oshkosh, WI (US)

(21) Appl. No.: 19/087,035

(22) Filed: Mar. 21, 2025

Related U.S. Application Data
(60) Provisional application No. 63/643,723, filed on May 7, 2024.
(60) Provisional application No. 63/643,608, filed on May 7, 2024.
(60) Provisional application No. 63/643,627, filed on May 7, 2024.
(60) Provisional application No. 63/643,788, filed on May 7, 2024.
(60) Provisional application No. 63/643,653, filed on May 7, 2024.
(60) Provisional application No. 63/643,617, filed on May 7, 2024.
(60) Provisional application No. 63/643,541, filed on May 7, 2024.
(60) Provisional application No. 63/643,528, filed on May 7, 2024.
(60) Provisional application No. 63/643,631, filed on May 7, 2024.
(60) Provisional application No. 63/712,662, filed on Oct. 28, 2024.
(60) Provisional application No. 63/713,023, filed on Oct. 28, 2024.
(60) Provisional application No. 63/712,647, filed on Oct. 28, 2024.
(60) Provisional application No. 63/712,602, filed on Oct. 28, 2024.
(60) Provisional application No. 63/712,621, filed on Oct. 28, 2024.
(60) Provisional application No. 63/741,768, filed on Jan. 3, 2025.
(60) Provisional application No. 63/741,710, filed on Jan. 3, 2025.
(60) Provisional application No. 63/775,273, filed on Mar. 20, 2025.

(51) Int. Cl. B66F 9/065; B60K 1/00; B60P 1/02; B60R 16/08; B62D 21/02; B66F 9/20

(52) U.S. Cl. CPC B66F 9/065; B60K 1/00; B60P 1/02; B60R 16/08; B62D 21/02; B66F 9/205

(57) ABSTRACT

A vehicle includes a frame, a drivetrain coupled to the frame, a base assembly coupled to the frame, and a lifting implement coupled to and supported on the base assembly. The lifting implement includes a platform, a cradle rotatably coupled to and supported on the platform so that the cradle, a scissor assembly coupled between the platform and the base assembly, and a lift actuator coupled between the base assembly and the scissor assembly. The lift actuator is configured to selectively raise the cradle relative to the base assembly. The lift actuator is a multi-stage telescoping actuator that includes a base stage, an intermediate stage, and an outer stage. The base stage is coupled to the base assembly, the outer stage is coupled to the scissor assembly, and the intermediate stage is arranged between the base stage and the outer stage.

### CROSS-REFERENCE TO RELATED PATENT APPLICATIONS

This application claims the benefit of and priority to (a) U.S. Provisional Patent Application 63/643,653, filed on May 7, 2024, (b) U.S. Provisional Patent Application 63/643,631, filed on May 7, 2024, (c) U.S. Provisional Patent Application 63/643,541, filed on May 7, 2024, (d) U.S. Provisional Patent Application 63/643,627, filed on May 7, 2024, (e) U.S. Provisional Patent Application 63/643,723, filed on May 7, 2024, (f) U.S. Provisional Patent Application 63/643,528, filed on May 7, 2024, (g) U.S. Provisional Patent Application 63/643,788, filed on May 7, 2024, (h) U.S. Provisional Patent Application 63/643,617, filed on May 7, 2024, (i) U.S. Provisional Patent Application 63/643,608, filed on May 7, 2024, (j) U.S. Provisional Patent Application 63/712,602, filed on Oct. 28, 2024, (k) U.S. Provisional Patent Application 63/712,621, filed on Oct. 28, 2024, (1) U.S. Provisional Patent Application 63/713,023, filed on Oct. 28, 2024, (m) U.S. Provisional Patent Application 63/712,662, filed on Oct. 28, 2024, (n) U.S. Provisional Patent Application 63/712,647, filed on Oct. 28, 2024, (o) U.S. Provisional Patent Application 63/741,768, filed on Jan. 3, 2025, (p) U.S. Provisional Patent Application 63/741,710, filed on Jan. 3, 2025, and (q) U.S. Provisional Patent Application 63/775,273, filed on Mar. 20, 2025, each of which is incorporated herein by reference in its entirety.

### BACKGROUND

The present disclosure relates generally to vehicles. More specifically, the present disclosure relates to vehicles utilized to transport material.

In a manufacturing environment, products are moved along a manufacturing line as various assembly processes are performed. In some such embodiments, the products are supported and/or propelled by vehicles. These vehicles may have varying ways of supporting the products and may incorporate varying levels of autonomy.

### SUMMARY

In some aspects, the present disclosure relates to a vehicle, including: a frame; a drivetrain coupled to the frame and including a drive motor configured to propel a tractive element; a base assembly coupled to the frame; and a lifting implement coupled to and supported on the base assembly, the lifting implement including: a platform; a cradle rotatably coupled to and supported on the platform; a scissor assembly coupled between the platform and the base assembly; and a lift actuator coupled between the base assembly and the scissor assembly so that the lift actuator is configured to selectively raise the cradle relative to the base assembly, wherein the lift actuator is a multi-stage telescoping actuator that includes a base stage, an intermediate stage, and an outer stage, and wherein the base stage is coupled to the base assembly, the outer stage is coupled to the scissor assembly, and the intermediate stage is arranged between the base stage and the outer stage.

In some aspects, the present disclosure relates to a vehicle, including: a frame; a drivetrain coupled to the frame and including a drive motor configured to propel a tractive element; a base assembly coupled to the frame; and a lifting implement coupled to and supported on the base assembly, the lifting implement includes: a platform; a cradle rotatably coupled to and supported on the platform, wherein the cradle includes an arcuate slot and a pin received within the arcuate slot, and wherein engagement between the pin and distal ends of the arcuate slot is configured to limit rotation of the cradle relative to the platform; a scissor assembly coupled between the platform and the base assembly; and a lift actuator coupled between the base assembly and the scissor assembly, wherein the lift actuator is configured to selectively raise the cradle relative to the base assembly.

In some aspects, the present disclosure relates to a vehicle, including: a frame; a drivetrain coupled to the frame and including a drive motor configured to propel a tractive element; a base assembly coupled to the frame; and a lifting implement coupled to and supported on the base assembly, the lifting implement includes: a platform; a cradle rotatably coupled to and supported on the platform, wherein the cradle includes a bracket assembly that is supported on a bracket plate, wherein the bracket assembly includes a fixed bracket and a movable bracket, wherein a channel or slot is defined between the fixed bracket and the movable bracket, and wherein a size of the channel or slot is selectively adjustable by lifting the movable bracket relative to the bracket plate to align a locking bar of the movable bracket with one of a plurality of locking slots formed in the bracket plate; a scissor assembly coupled between the platform and the base assembly; and a lift actuator coupled between the base assembly and the scissor assembly, wherein the lift actuator is configured to selectively raise the cradle relative to the base assembly.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which.

FIG. 1 is a perspective view of a vehicle according to an exemplary embodiment.

FIG. 2 is a top view of the vehicle of FIG. 1.

FIG. 3 is a perspective view of the vehicle of FIG. 1 equipped with a lifting implement, according to an exemplary embodiment.

FIG. 4 is a perspective view of the vehicle of FIG. 3 and another vehicle cooperating to support a telehandler, according to an exemplary embodiment.

FIG. 5 is a perspective view of the vehicle of FIG. 1 equipped with a cart implement, according to an exemplary embodiment.

FIG. 6 is a perspective view of the vehicle of FIG. 3 interfacing with a cart supporting a boom assembly, according to an exemplary embodiment.

FIG. 7 is a block diagram of a control system for the vehicle of FIG. 1.

FIG. 8 is a top view of a production system including the vehicle of FIG. 1, according to an exemplary embodiment.

FIG. 9 is a perspective view of the lifting implement of FIG. 3, according to an exemplary embodiment.

FIG. 10 is a perspective view of the lifting implement of FIG. 9.

FIG. 11 is a bottom perspective view of the lifting implement of FIG. 9.

FIG. 12 is a perspective view of the lifting implement of FIG. 9 with a scissor assembly in a lowered position.

FIG. 13 is a perspective view of the lifting implement of FIG. 9 with a scissor assembly in a raised position and a support prop in an unlocked position.

FIG. 14 is a perspective view of the lifting implement of FIG. 9 with a scissor assembly in a raised position and a support prop in an unlocked position.

FIG. 15 is a perspective view of a scissor assembly of the lifting implement of FIG. 9.

FIG. 16 is a top perspective view of the lifting implement of FIG. 9.

FIG. 17 is a perspective view of a product received within a cradle of the lifting implement of FIG. 9, according to an exemplary embodiment.

FIG. 18 is a top perspective view of the lifting implement with a cradle rotated, according to an exemplary embodiment.

FIG. 19 is a bottom perspective view of a cradle of the lifting implement of FIG. 9.

FIG. 20 is a bottom perspective view of a cradle of the lifting implement of FIG. 9.

FIG. 21 is a perspective view of the lifting implement with a support prop in a locked position.

FIG. 22 is a perspective view of the lifting implement with a support prop in a locked position.

FIG. 23 is a perspective view of the lifting implement with a support prop in a locked position.

FIG. 24 is a perspective view of the lifting implement with a support prop in a locked position.

FIG. 25 is a perspective view of the lifting implement with a support prop in an unlocked position.

FIG. 26 is a cross-sectional view of the lifting implement with a lift actuator in an extended position.

FIG. 27 is a cross-sectional view of the lifting implement with a lift actuator in an extended position.

FIG. 28 is a cross-sectional view of the lifting implement with a lift actuator in a retracted position.

FIG. 29 is a cross-sectional view of the lifting implement with a lift actuator in a retracted position.

FIG. 30 is a cross-sectional view of the lifting implement with a lift actuator in a retracted position.

FIG. 31 is a cross-sectional view of the lifting implement with a lift actuator in a retracted position.

FIG. 32 is a cross-sectional view of the lifting implement with a lift actuator in an extended position.

FIG. 33 is a perspective view of a vehicle with a lifting implement in a retracted position, according to an exemplary embodiment.

FIG. 34 is a perspective view of the vehicle of FIG. 33 with a lifting implement in an extended position, according to an exemplary embodiment.

FIG. 35 is a top view of the vehicle of FIG. 33, according to an exemplary embodiment.

FIG. 36 is a top perspective view of a cradle of the vehicle of FIG. 33, according to an exemplary embodiment.

FIG. 37 is a bottom perspective view of the cradle of FIG. 36.

FIG. 38 is a perspective view of a scissor assembly of the vehicle of FIG. 33, according to an exemplary embodiment.

FIG. 39 is a perspective view of a scissor assembly of the vehicle of FIG. 33, according to an exemplary embodiment.

FIG. 40 is a perspective view of a scissor assembly of the vehicle of FIG. 33, according to an exemplary embodiment.

FIG. 41 is an enlarged side perspective view of a position arm of the vehicle of FIG. 33, according to an exemplary embodiment.

FIG. 42 is an enlarged rear perspective view of a position arm of the vehicle of FIG. 33, according to an exemplary embodiment.

FIG. 43 is a perspective view of the vehicle of FIG. 33 including a pump, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a vehicle that is utilized in a manufacturing line or process is shown. The vehicle includes a frame and a base assembly coupled to the frame. The base assembly is configured to couple various implements to the frame, and the implements facilitate positioning, supporting, and/or lifting of a component of a product (e.g., a telehandler or an axle assembly of a telehandler). In some embodiments, the implement includes a lift implement with a cradle that receives and supports the component of the product and a lift assembly coupled between the cradle and the base assembly. The lift assembly includes a plurality of lift arms that are pivotably coupled to one another (e.g., a scissor stack or a scissor assembly). A lift actuator is coupled between the base assembly and the lift arms and is configured to selectively raise the cradle relative to the base assembly. In some embodiments, the lift actuator is in the form of a multi-stage telescoping actuator that includes a base stage, an intermediate or middle stage, and an end or distal stage. The inclusion of a multi-stage actuator facilitates a compact arrangement of the lift assembly, for example, when fully retracted (e.g., greater extension range or stroke but smaller size when fully retracted). In some embodiments, the lift actuator is hydraulically controlled and operated by a lift valve that selectively supplies hydraulic fluid (e.g., oil) to the lift actuator to extend one or more stages of the lift actuator. In some embodiments, the stages of the lift actuator are retracted by gravity and the weight acting on the cradle.

In some embodiments, the lift assembly includes a support prop or prop wing arranged to both lateral sides of the scissor assembly that is configured to permit extension of the lift actuator but that acts in compression to resist retraction of the scissor assembly. In general, the prop wings acts to hold the cradle in one of various raised positions, for example, in the event of a power or pressure failure, to prevent the cradle from involuntarily retracting toward the base assembly. In some embodiments, the prop wings are pivotably coupled to the scissor assembly and each include a plurality of recesses or notches that are configured to engage a pin of the scissor assembly. The prop wings are biased, for example via gravity and/or a gas spring, in a direction that urges one of the notches into engagement with the pin of the scissor assembly. When one of the notches engages and receives the pin, the scissor assembly is prevented from retracting and held in its raised position. With the prop wings each including a plurality of notches, the prop wings are configured to operate and hold the cradle in a plurality of raised positions. In some embodiments, the prop wings are each coupled to a prop actuator that are configured to selectively pivot the prop wings out of engagement with the pin to enable the cradle to be lowered.

In some embodiments, the cradle is supported on and rotatably coupled to a top platform. For example, the cradle is rotatable about a vertical axis, which allows the cradle to rotate relative to the frame/base assembly and enables steering operation of the vehicle, for example, when the product is supported by and spans between two of the vehicles. In some embodiments, the cradle includes an arcuate slot within which a pin (e.g., a shoulder bolt) is received, and the ends of the arcuate slot limit the rotational movement of the cradle relative to the top platform and the frame/base assembly.

In some embodiments, the cradle includes a pair of laterally separated bracket assemblies that define a channel or slot within which the component (e.g., an axle assembly of a telehandler is received). The bracket assemblies each include a fixed bracket and a movable bracket. The movable bracket is configured to be selective moved relative to the fixed bracket to adjust (e.g., increase or decrease) a distance between the movable bracket and the fixed bracket, which allows the cradle to receive different sized components (e.g., an axle of a telehandler).

### Overall Vehicle

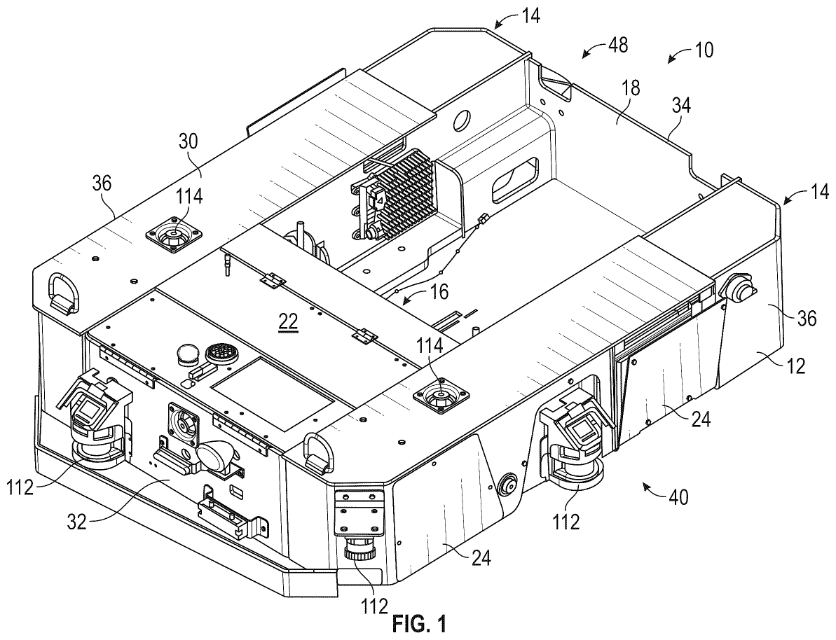

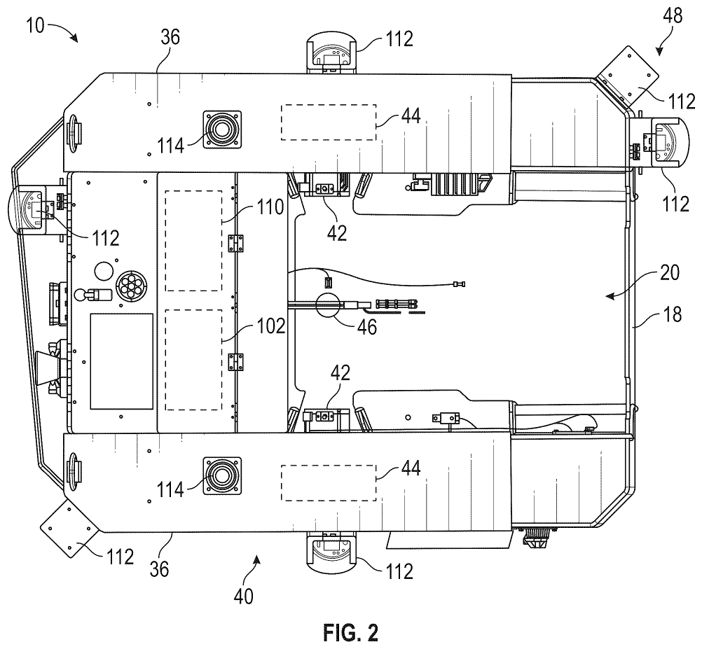

Referring to FIGS. 1 and 2, a machine, vehicle, trolley, transport, hauler, mule, or tug, is shown as vehicle 10 according to an exemplary embodiment. The vehicle 10 may be configured to support, push, pull, turn, or otherwise facilitate movement of a product or components of a product throughout a manufacturing environment. By way of example, the vehicle 10 may move a product (e.g., another vehicle or machine) along a manufacturing line as the product is assembled. The vehicle 10 may move the product between stations where different assembly operations are performed. Additionally or alternatively, the vehicle 10 may be used to move parts or subassemblies (e.g., booms, engines, tires, etc.) throughout the manufacturing environment (e.g., to the product, to a storage area, etc.).

The vehicle 10 may be manually controlled, partially autonomous, or fully autonomous. In some embodiments, the vehicle 10 is configured as a semi-automated guided vehicle (SGV). When configured as an SGV, the vehicle 10 may be manually operated by an operator (e.g., through a wireless or tethered user interface). By way of example, the operator may manually control the steering of the vehicle 10. In some embodiments, the vehicle 10 is configured as an automated guided vehicle (AGV). When configured as an AGV, the vehicle 10 may navigate along a predefined route (e.g., using a magnetic strip or other fixed navigation element). If the vehicle 10 configured as an AGV encounters an obstacle, the vehicle 10 may rely on manual intervention from an operator (e.g., through a user interface) to correct course and navigate around the obstacle. In some embodiments, the vehicle 10 is configured as an autonomous mobile robot (AMR). When configured as an AMR, the vehicle 10 may autonomously navigate through an area without requiring a predefined path. The vehicle 10 configured as an AMR may avoid obstacles without manual intervention by an operator.

The vehicle 10 includes a chassis, shown as frame 12, that supports the other components of the vehicle 10. In some embodiments, the frame 12 defines an enclosure that contains one or more components of the vehicle 10. The frame 12 includes a pair of side portions, shown as drive modules 14, a central portion, shown as controls enclosure 16, and a lateral member, shown as back plate 18. The drive modules 14 each extend longitudinally along the vehicle 10 and are laterally offset from one another. The controls enclosure 16 and the back plate 18 each extend laterally between the drive modules 14, fixedly coupling the drive modules 14 to one another. The controls enclosure 16 and the back plate 18 are longitudinally offset from one another, such that a recess or passage, shown as implement recess 20, is defined between the controls enclosure 16, the back plate 18, and the drive modules 14.

The drive modules 14 may contain components that facilitate propulsion of the vehicle (e.g., the drivetrain 40). The drive modules 14 may include one or more removable or repositionable panels, shown as drive module doors 24, that facilitate access to components within the drive modules 14 from outside of the vehicle 10. The controls enclosure 16 may contain components that facilitate powering or control over the vehicle (e.g., the controller 102, the batteries 110). The controls enclosure 16 includes a removable or repositionable panel, shown as controls enclosure door 22, that facilitates access to components within the controls enclosure 16 from outside of the vehicle 10. In other embodiments, the vehicle 10 includes a separate housing, body, or enclosure that is coupled to the frame 12 and contains one or more components of the vehicle.

The frame 12 defines a top surface 30, a front surface 32, a rear surface 34, and a pair of side surfaces 36 of the vehicle 10. The top surface 30 extends substantially horizontally across the drive modules 14 and the controls enclosure 16. A distance from the top surface 30 to the ground beneath the vehicle 10 may define a height of the vehicle 10. The front surface 32 is positioned at a front end portion of the frame 12 and extends substantially vertically and laterally across the drive modules 14 and the controls enclosure 16. The rear surface 34 is positioned at a rear end portion of the frame 12 and extends substantially vertically and laterally across the drive modules 14 and the back plate 18. The side surfaces 36 each extend longitudinally along one of the drive modules 14, between the front surface 32 and the rear surface 34.

The vehicle 10 includes a drive system or driveline, shown as drivetrain 40, that is configured to propel and steer the vehicle 10. The driveline includes a pair of actuators or motors (e.g., hydraulic motors, pneumatic motors, electric motors, etc.), shown as drive motors 42. In some embodiments, the drive motors 42 are electric motors powered by an electrical energy source (e.g., the batteries 110, energy from a power grid external to the vehicle 10, etc.). The drive motors 42 are each configured to provide rotational mechanical energy to drive rotation of one or more tractive elements 44 (e.g., wheel and tire assemblies). In some embodiments, the drive motors 42 drive the left and right sides of the drivetrain 40 independently, facilitating skid steer operation of the vehicle 10. By way of example, the tractive elements 44 may be driven at the same speed and in the same direction to travel straight. By way of another example, the tractive elements 44 may be driven at different directions and/or at different speeds to turn the vehicle 10. By driving the tractive elements 44 at the same speed and in opposite directions, the drivetrain 40 may rotate the vehicle 10 about a substantially vertical axis, shown as central axis 46, that is substantially centered relative to the frame 12. Rotation of the vehicle 10 about the central axis 46 may facilitate reorienting the vehicle 10 without changing position (i.e., turning in place).

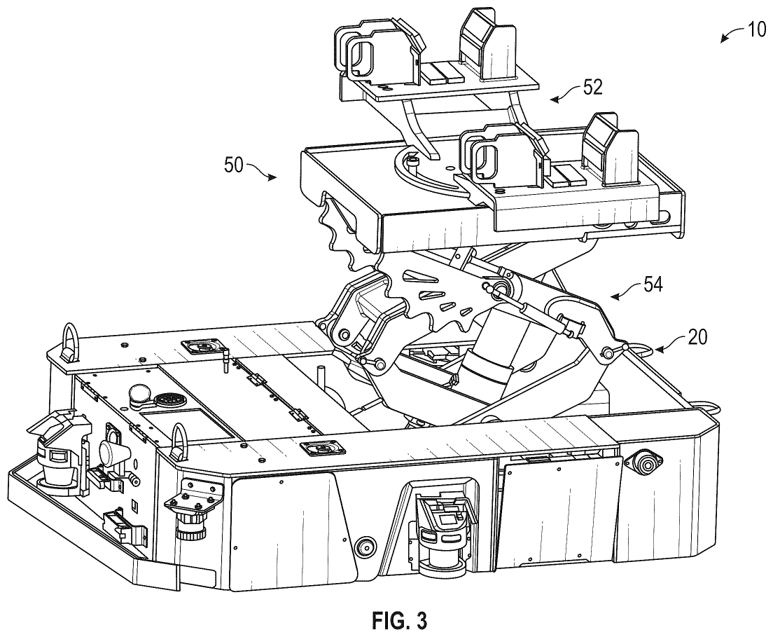

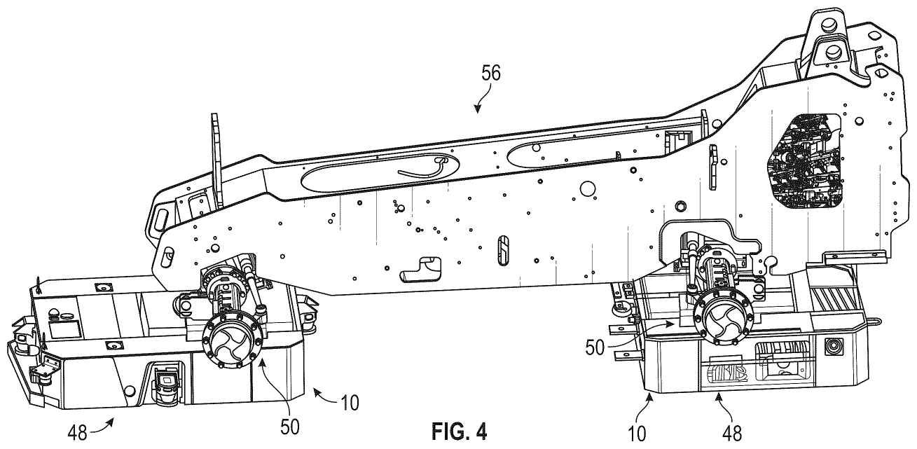

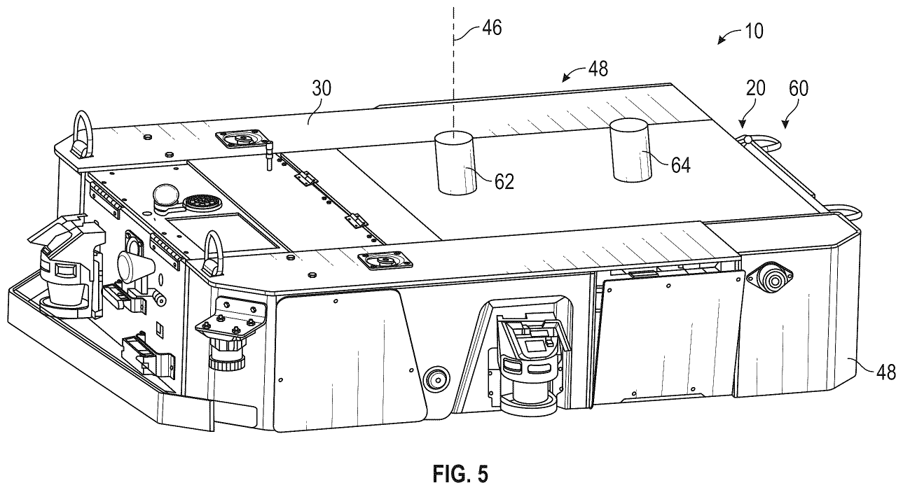

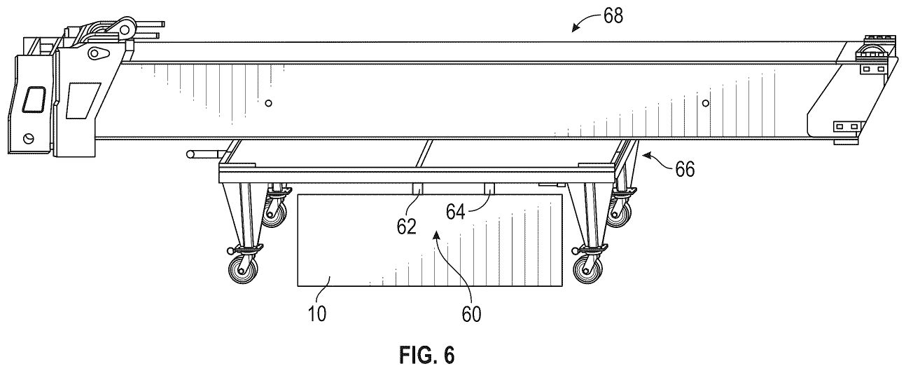

The frame 12, the drivetrain 40, and various other components coupled to the frame 12 form a base portion of the vehicle 10, shown as base assembly 48. To facilitate moving a product, the vehicle 10 may include an implement that that selectively couples the base assembly 48 to a product. FIGS. 3 and 4 illustrate a first implement, shown as lifting implement 50, and FIGS. 5 and 6 illustrate a second implement, shown as cart implement 60. Each implement may be received within the implement recess 20 and fixedly coupled to the frame 12. In some embodiments, the implement is removable from the implement recess 20 to facilitate interchanging with another type of implement. By way of example, the lifting implement 50 may be removed and replaced with the cart implement 60. In other embodiments, the implement is permanently installed on the vehicle.

Referring to FIGS. 3 and 4, the lifting implement 50 includes a product interface, shown as cradle 52, and a lift device or lifting assembly, shown as lift assembly 54. The cradle 52 is configured to receive and directly support a product, shown as telehandler 56. By way of example, the cradle 52 may receive an axle assembly of the telehandler 56. The lift assembly 54 couples the cradle 52 to the frame 12. The lift assembly 54 may be extended to raise the cradle 52 or retracted to lower the cradle 52. Accordingly, the lift assembly 54 may be used to raise or lower the telehandler 56.

Certain large products, such as the telehandler 56, may be difficult to support with only a single vehicle 10. To facilitate steering the product and spreading out the weight of the product, multiple vehicles 10 may be utilized. In the example shown in FIG. 4, a front axle of the telehandler 56 is supported by one vehicle 10, and a rear axle of the telehandler 56 is supported by another vehicle 10. In some embodiments, the vehicles 10 are independently operable. In other embodiments, operation of one vehicle 10 is dependent upon the other vehicle 10. By way of example, a first vehicle 10 may supply electrical energy to, propel, and/or control operation of the other vehicle 10.

Referring to FIGS. 5 and 6, the cart implement 60 includes a pair of protruding interface elements (e.g., pins), extending above the top surface 30. Specifically, the cart implement 60 includes a central pin, shown as driving pin 62, and an offset pin, shown as turning pin 64, that can each be selectively raised and lowered by an actuator of the cart implement 60. The driving pin 62 is centered about the central axis 46, and the turning pin 64 is offset from the central axis 46. The driving pin 62 and the turning pin 64 are positioned to a mobile platform, shown as cart 66, that supports a product subassembly, shown as boom assembly 68.

When extended, the driving pin 62 and the turning pin 64 each engage the cart 66 to limit movement of the cart 66 relative to the base assembly 48. When both the driving pin 62 and the turning pin 64 engage the cart 66, the cart 66 may be fixed to the base assembly 48. When only the driving pin 62 engages the cart 66, the base assembly 48 may rotate freely about the central axis 46 relative to the cart 66, but movement of the vehicle 10 in a particular direction may cause movement of the cart 66 in that same direction. When the driving pin 62 and the turning pin 64 are both retracted away from the cart 66, the vehicle 10 may move freely relative to the cart 66.

The cart 66 may be equipped with casters or slides to facilitate free movement of the cart 66 along the ground. In some embodiments, the cart 66 supports some or all of the weight of the boom assembly 68. The driving pin 62 and the turning pin 64 may generally push horizontally on the cart 66, such that there may be little or no transmission of vertical forces between the cart implement 60 and the cart 66. Accordingly, the vertical load on the vehicle 10 may be minimized while still permitting the vehicle 10 move the cart 66 and the boom assembly 68 throughout the environment as desired. This reduction in load may reduce the overall cost of the vehicle 10.

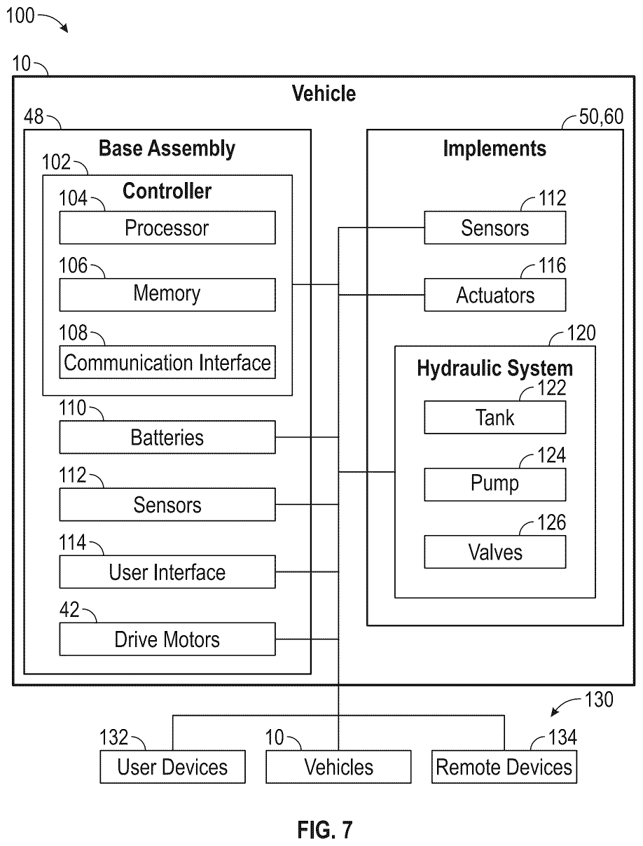

Referring to FIG. 7, the vehicle 10 and a control system 100 for the vehicle 10 are shown according to an exemplary embodiment. The control system 100 may facilitate operation of the vehicle 10 and/or other devices of a production environment. Although certain components are shown as being included in the base assembly 48 and/or the implements 50 and 60, it should be understood that any component may be positioned in the base assembly 48, the lifting implement 50, or the cart implement 60 or duplicated across multiple thereof.

The vehicle 10 includes a controller 102 that controls operation of the vehicle 10. The controller 102 includes a processing circuit, shown as processor 104, and a memory device, shown as memory 106. The memory 106 may contain one or more instruction that, when executed by the processor 104, cause the processor to perform the various functions described herein.

The controller 102 further includes a communication interface 108 (e.g., a communication circuit, a network interface, etc.) that facilitates communication with (e.g., to and from) other components of the vehicle 10 and/or the control system 100. The communication interface 108 may facilitate wired communication (e.g., through CAN, Ethernet, communication of power, etc.). Additionally or alternatively, the communication interface 108 may facilitate wireless communication (e.g., through Bluetooth, Wi-Fi, radio transmission, inductive transmission of energy, etc.).

The base assembly 48 includes one or more energy storage devices, shown as batteries 110. The batteries 110 store energy (e.g., as chemical energy). The batteries 110 may deliver electrical energy to other components of the vehicle 10 to power the vehicle 10. The batteries 110 may be charged by an outside source of energy (e.g., an electrical grid, a wireless charging interface, etc.). In other embodiments, the base assembly 48 includes a different type of energy storage device (e.g., a fuel tank for an internal combustion engine of a generator, a fuel cell, etc.).

The base assembly 48, the lifting implement 50, and the cart implement 60 may each include one or more sensors 112 operatively coupled to the controller 102. The sensors 112 may provide sensor data describing the current status of the vehicle 10 and/or the surrounding environment. By way of example, the sensors 112 may include mapping or imaging sensors (e.g., LIDAR sensors, light curtains, cameras, ultrasonic sensors, etc.). By way of example, the sensors 112 may include position sensors (e.g., GPS, potentiometers, encoders, etc.). By way of example, the sensors 112 may include orientation or acceleration sensors (e.g., accelerometers, gyroscopic sensors, inertial measurement units, compasses, etc.). By way of example, the sensors 112 may include pressure sensors, flowmeters, buttons, or other types of sensors.

The base assembly 48 may include one or more operator interface elements (e.g., input devices, output devices, etc.), shown as user interface 114. The user interface 114 may include output devices that provide information to one or more users. By way of example, the user interface 114 may include displays, speakers, lights, haptic feedback (e.g., vibrators, etc.), or other output devices. The user interface 114 may include input devices that receive information (e.g., commands) from one or more users. By way of example, the user interface 114 may include buttons, switches, knobs, touchscreens, microphones, or other input devices.

The lifting implement 50 and/or the cart implement 60 may include one or more actuators 116 that facilitate controlled movement (e.g., movement of the lifting implement 50 or the cart implement 60). The actuators 116 may include linear actuators (e.g., electric linear actuators, hydraulic cylinders, etc.), motors (e.g., electric motors, hydraulic motors, etc.), or other types of actuators. The actuators 116 may be electrically-powered, hydraulically-powered, or otherwise powered.

The lifting implement 50 and/or the cart implement 60 may include a hydraulic system 120. They hydraulic system 120 may supply pressurized hydraulic fluid (e.g., hydraulic oil) to facilitate operation of other components of the vehicle 10. By way of example, the hydraulic system 120 may supply pressurized hydraulic fluid to an actuator 116. In some embodiments, the hydraulic system 120 forms a self-contained hydraulic loop with one or more actuators 116.

The hydraulic system 120 includes a low-pressure reservoir, shown as tank 122, that stores a volume of hydraulic fluid at a low pressure. A pump 124 receives electrical energy from the batteries 110, draws hydraulic fluid from the tank 122, and supplies a flow of pressurized hydraulic fluid. One or more valves 126 (e.g., solenoid valves, directional control valves, etc.) control the flow of the hydraulic fluid from the pump 124. By way of example, the valves 126 may control the flow rate, direction, and destination of hydraulic fluid flowing throughout the hydraulic system 120. The controller 102 may control operation of the actuators 116 by controlling the valves 126.

The control system 100 further includes additional devices in communication with the vehicle 10. The devices may communicate with the vehicle 10 directly or through a network 130 (e.g., a local area network, a wide area network, the Internet, etc.). The network 130 may utilize wireless and/or wired communication. In some embodiments, the network 130 is a mesh network formed between multiple devices of the control system 100 (e.g., permitting indirect communication between two devices through a third device).

The control system 100 may include multiple vehicles 10. A vehicle 10 may communicate with other vehicles 10 to share information and facilitate operation. By way of example, a vehicle 10 may provide commands to another vehicle 10 to coordinate transportation of a large item that is carried by both of the vehicles 10. By way of another example, a vehicle 10 may provide its location to another vehicle 10 to facilitate path generation and avoid collisions.

The control system 100 may include one or more user devices 132 (e.g., smartphones, tablets, laptops, desktop computers, etc.). The user devices 132 may facilitate a user monitoring and/or controlling operation of the vehicles 10. By way of example, the user devices 132 may indicate statuses of the vehicles 10 (e.g., positions, whether maintenance is needed, if any errors are occurring, what task a vehicle 10 is assigned, etc.). By way of example, the user devices 132 may permit a user to command a vehicle 10 to travel to a different place or to assign a vehicle 10 to a particular production line.

The control system may include one or more remote devices 134 (e.g., servers). In some embodiments, a remote device 134 functions as a production manager that controls various operations throughout a manufacturing environment. The production manager may receive requests for production of certain equipment (e.g., fifteen telehandlers are requested for production by Apr. 12, 2025, etc.). The production manager may monitor the statuses of vehicles 10, personnel, equipment, and raw materials. By way of example, the vehicles 10 may provide sensor data from the sensors 112 to a remote device 134 for storage and/or analysis. Based on the available data, the production manager may generate assignments for vehicles 10, personnel, equipment, and raw materials to meet the production requests. The production manager may adapt to changes in availability (e.g., by reassigning a vehicle 10 to a different task or area in response to a failure of one of the vehicles 10). The assignments for a vehicle 10 may include a path along which the vehicle 10 should travel, a desired configuration of the vehicle 10 (e.g., the type of implement available to the vehicle 10), an amount of time that the vehicle 10 should wait at a given station, etc.

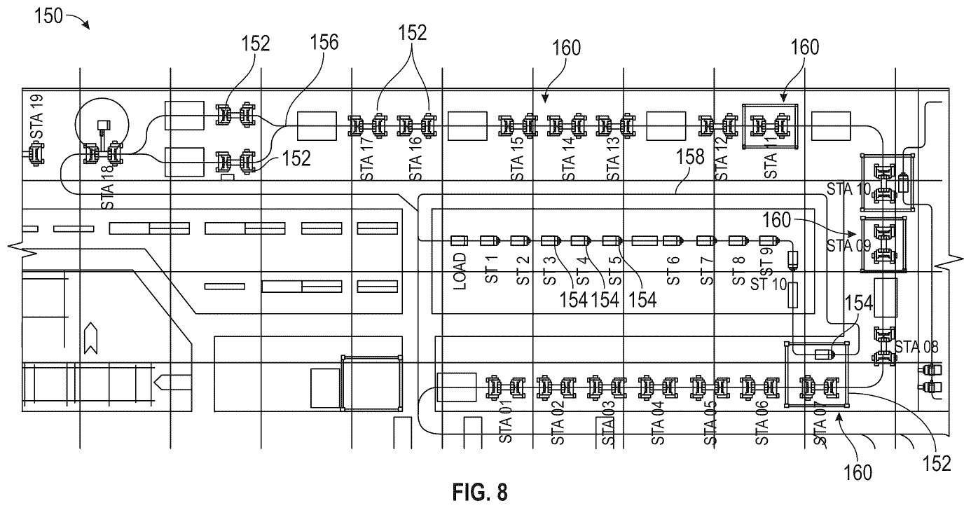

Referring to FIG. 8, a manufacturing environment or production system 150 is shown according to an exemplary embodiment. The production system 150 may include a series of vehicles 10 that move a product 152 and a subassembly 154 through various stages of assembly (e.g., as controlled by a remote device 134). The vehicles 10 move the product 152 along a first path, shown as manufacturing line 156, and the vehicles 10 move the subassembly 154 along a second path, shown as manufacturing line 158. A series of manufacturing or assembly stations, shown as stations 160, are spaced at regular intervals along the manufacturing lines 156 and 158. Each station 160 may be associated with a different manufacturing or assembly process that is performed there. By way of example, there may be stations 160 for attaching components to a product 152, coupling components with hoses or wires, confirming that certain functions are operating properly, etc.

Initially the product 152 and the subassembly 154 move along separate manufacturing lines 156 and 158. After the last station 160 needed to prepare the subassembly 154, the manufacturing line 158 intersects the manufacturing line 156, and the subassembly 154 is attached to the product 152. The product 152 and the subassembly 154 then move together along the manufacturing line 156. This proceeds until the product 152 is fully assembled and removed from the vehicles 10. The vehicles 10 may then return to collect another product that requires assembly, and the manufacturing process is repeated.

In some embodiments, the product 152 assembled by the production system is a vehicle or work machine. By way of example, the product 152 may be a lift device, such as a telehandler, a scissor lift, a boom lift, a vertical lift, an aerial work platform, or another type of lift device. By way of another example, the product 152 may be a fire truck, an aircraft rescue and firefighting apparatus (ARFF) truck, a refuse vehicle, a concrete mixing truck, a tow truck, a broadcast van, a military vehicle, a robot, a truck, a van, a passenger vehicle, or another type of vehicle. In other embodiments, the product 152 is not a vehicle (e.g., is a stationary piece of equipment).

### Lifting Implement

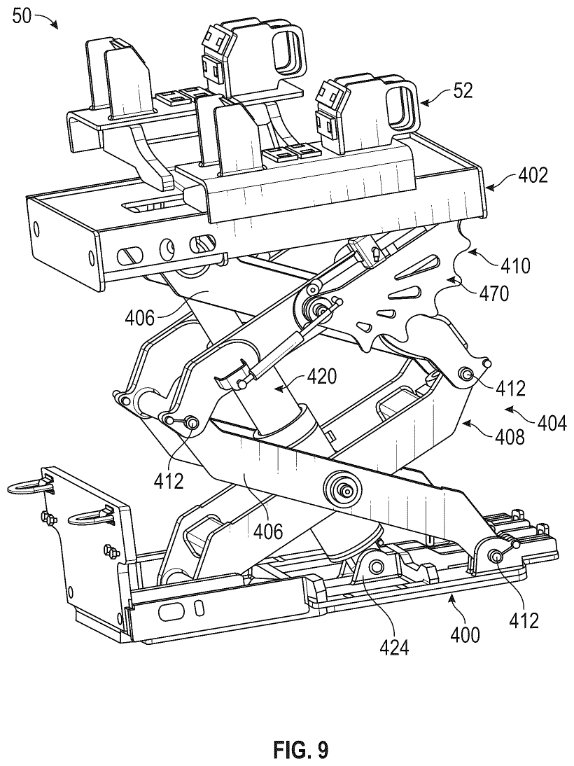

As described herein, the base assembly 48 of the vehicle 10 may be selectively coupled to an implement that facilitates supporting and/or moving of the component or product. In some embodiments, the base assembly 48 is coupled to the lifting implement 50 that both supports the product and selectively raises and lowers the product relative to the base assembly 48. FIGS. 9-17 illustrated the lifting implement 50 according to an exemplary embodiment. The lifting implement 50 includes the cradle 52, the lift assembly 54, a bottom plate or platform 400, and an upper plate or platform 402. The bottom platform 400 may be selectively coupled to or form part of the base assembly 48. In this way, for example, the bottom platform 400 may couple the lifting implement 50 to the frame 12 of the vehicle 10. The cradle 52 is rotatably coupled to and supported on the top platform 402.

In some embodiments, the lift assembly 54 includes a scissor assembly 404 formed by a plurality of lift arms 406 that are pivotably coupled to one another in a crisscross or X-shaped arrangement. The scissor assembly 404 is coupled between the bottom platform 400 (e.g., the base assembly 48) and the top platform 402. In some embodiments, each of the lift arms 406 is in the form of a lift plate. The lift arms 406 may include a lower section 408 and an upper section 410. The lower section 408 includes a plurality of the lift arms 406, with each of the lift arms 406 in the lower section 408 being pivotably coupled to the bottom platform 400 at one end and to a respective one of the lift arms 406 in the upper section 410 at an opposing end. The upper section 410 includes a plurality of the lift arm 406, with each of the lift arms 406 in the upper section 410 being pivotably coupled to a respective one of the lift arms 406 in the lower section 408 at one end and to the top platform 402 at an opposing end.

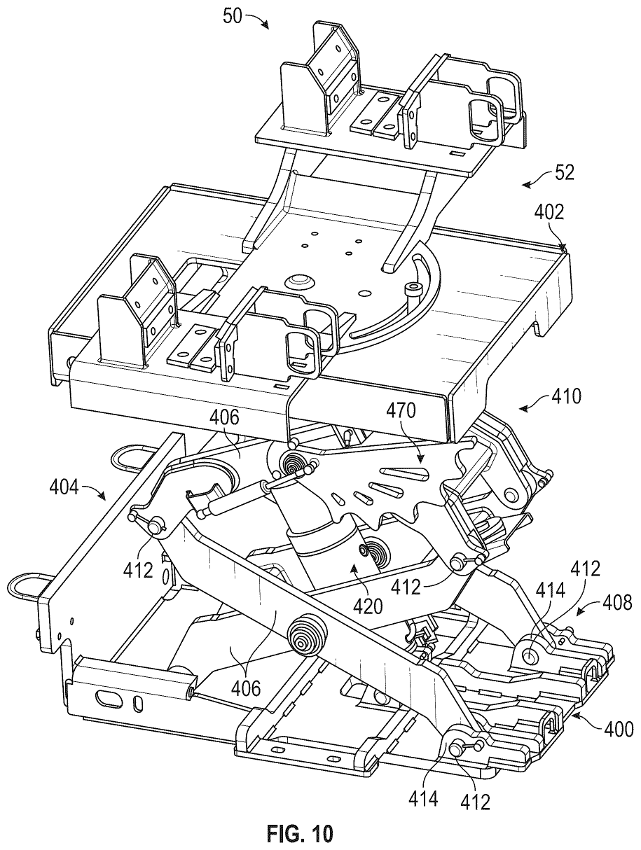

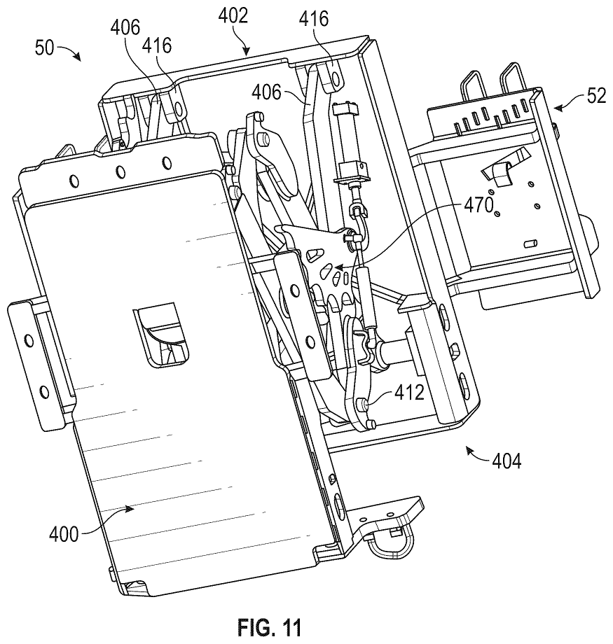

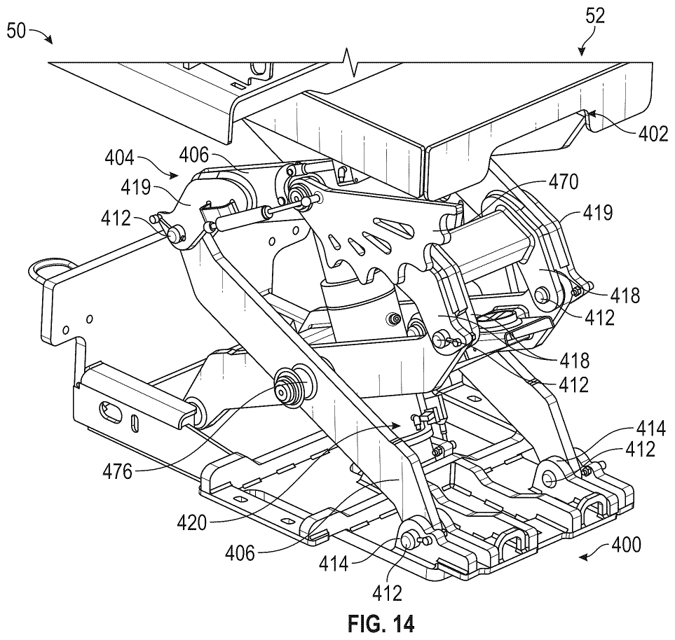

The ends of each of the lift arms 406 are pivotably coupled to the bottom platform 400, the top platform 402, or another end of one of the lift arms 406 by a pivot pin 412. For example, at least two of the lift arms 406 in the lower section 408 are pivotably coupled at one end to the bottom platform 400 by one of the pivot pins 412 that extends through a base bracket 414 (see, e.g., FIGS. 10 and 14). The base bracket 414 is rigidly coupled to the bottom platform 400 so that the ends of the lift arms 406 that are coupled to the bottom platform 400 are fixed (e.g., do not move relative to) to the bottom platform 400. At least two of the lift arms 406 in the upper section 410 are pivotably coupled at one end to the top platform 402 by one of the pivot pins 412 that extends through a top bracket 416 (see, e.g., FIG. 11). The top brackets 416 are rigidly coupled to a lower or bottom side of the top platform 402 so that the ends of the lift arms 406 that are coupled to the top platform 402 are fixed (e.g., do not move relative to) to the top platform 402.

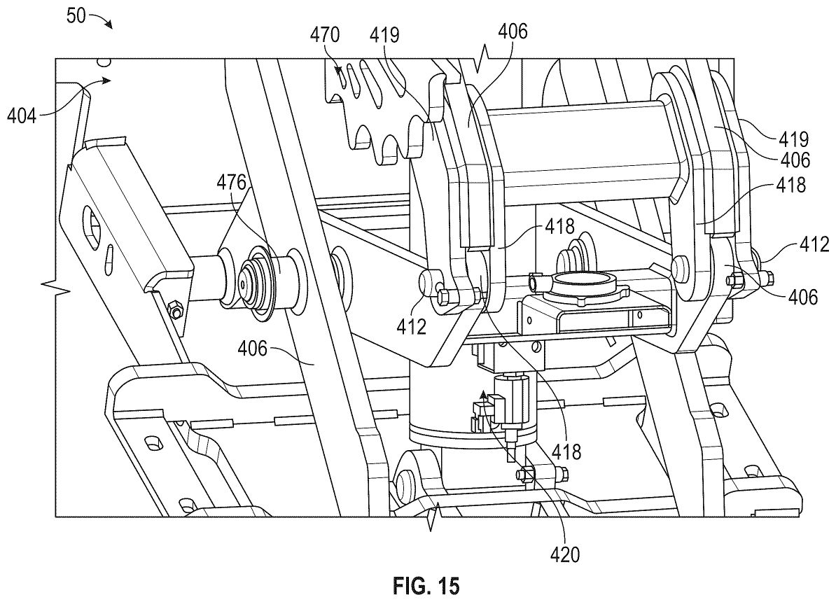

The ends of the lift arms 406 of the upper section 410 that are pivotably coupled to another end of one of the lift arms 406 in the lower section 408 (e.g., an end not coupled to the top platform 402) are rigidly coupled to a pair of intermediate brackets. For example, each lower end of the lift arms 406 in the upper section 410 is rigidly coupled to (e.g., welded) an inner intermediate bracket 418 and an outer intermediate bracket 419 (see, e.g., FIGS. 14-15). The ends of the lift arms 406 in the lower section 408 are received between the inner intermediate bracket 418 and the outer intermediate bracket 419, and one of the pivot pins 412 extends through the inner intermediate bracket 418, the outer intermediate bracket 419, and the end of the lift arm 406 in the lower section 408 to pivotably couple the ends of the lift arms 406 in the lower section 408 and the upper section 410. The pivot coupling formed between lower section 408 and the upper section 410 by the inner intermediate bracket 418 and the outer intermediate bracket 419 allows the lift arms 406 in the lower section 408 and the upper section 410 to occupy a common plane. In addition, the pivotal coupling formed between the lift arms 406 in the lower section 408 and the upper section 410 at the intermediate brackets 418, 419 is movable so that the ends of the lift arms 406 and the intermediate brackets 418, 419 (and the pivot pins 412 extending therethrough) move relative to the bottom platform 400 as the scissor assembly 404 is raised and lowered.

In some embodiments, each of the pivot pins 412 may be in a double shear arrangement (e.g., bracket—lift arm—bracket). For example, each of the base brackets 414 receives an end of a respective one of the lift arms 406 in the lower section 408, so that the end of the lift arm 406 is arranged between two bracket lobes of the base bracket 414 (e.g., a bracket lobe is arranged on both lateral sides of the lift arm 406). The pivot pin 412 extends through each bracket lobe of the base bracket 414 and the lift arm 406 to form a double shear arrangement (see, e.g., FIG. 14). Each of the top brackets 416 receives an end of a respective one of the lift arms 406 in the upper section 410, so that the end of the lift arm 406 is arranged between two bracket lobes of the top bracket 416 (e.g., a bracket lobe is arranged on both lateral sides of the lift arm 406). The pivot pin 412 extends through each bracket lobe of the top bracket 416 and the lift arm 406 to form a double shear arrangement (see, e.g., FIG. 11). Each corresponding pair of the inner intermediate bracket 418 and the outer intermediate bracket 419 receives an end of one of the lift arms 406 of the lower section 408 therebetween (e.g., one of the inner intermediate bracket 418 and the outer intermediate bracket 419 is arranged on both lateral sides of the lift arm 406). The pivot pin 412 extends through the inner intermediate bracket 418, the outer intermediate bracket 419, and the end of the lift arm 406 in the lower section 408 to form a double shear arrangement (see, e.g., FIGS. 14-15).

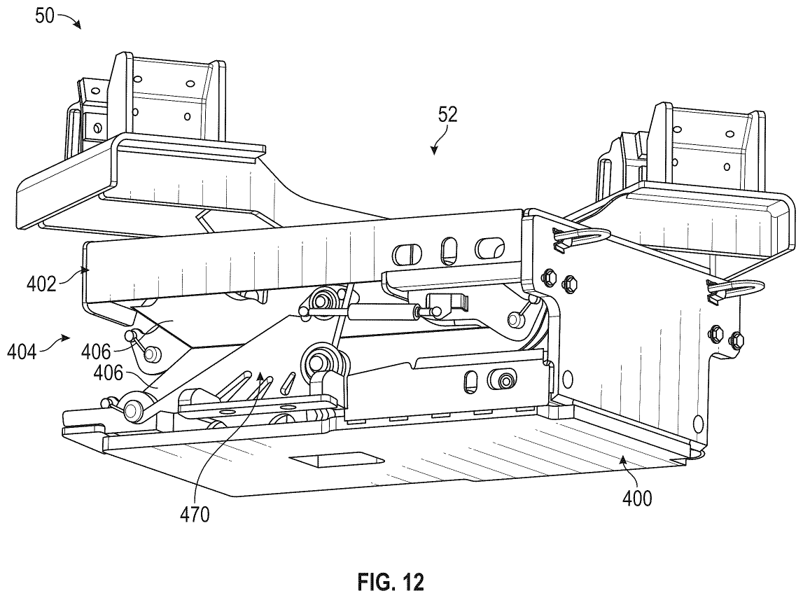

As described herein, the lifting implement 50 may includes one or more of the actuators 116 to facilitate controlled movement of various components of the lifting implement 50. In some embodiments, the lifting implement 50 includes a lift actuator 420 and one or more prop actuators 422. In general, the lift actuator 420 is configured to selectively raise the scissor assembly 404 and the top platform 402 (and the cradle 52 supported thereon). For example, the scissor assembly 404 (and the top platform 402 and the cradle 52) are movable between a raised position (see, e.g., FIG. 9-10) and a lowered or stowed position (see, e.g., FIG. 12). In the raised position, the top platform 402 and the cradle 52 are extended from the bottom platform 400 a greater distance than when the top platform 402 and the cradle 52 are in the lowered position.

The lift actuator 420 is coupled between the bottom platform 400 (and the base assembly 48 coupled thereto) and the scissor assembly 404. Specifically, one end (e.g., a base end) of the lift actuator 420 is rigidly coupled to the bottom platform 400 by an actuator bracket 424 so that the base end of the lift actuator 420 is fixed to the bottom platform 400, and an opposite end (e.g., outer or distal end) of the lift actuator 420 is coupled to a pair of the lift arms 406 in the upper section 410 (e.g., a pair of lift arms 406 that are also coupled to the top platform 402). In this way, for example, extension of the lift actuator 420 displaces the scissor assembly 404, and the top platform 402 and the cradle 52, toward the raised position where the top platform 402 and the cradle 52 move in a direction away from the bottom platform 400 and the base assembly 48. In some embodiments, the lift actuator 420 may be configured to extend toward an extended position, which corresponds with the raised position of the cradle 52, the top platform 402, and the scissor assembly 404, via one of the valves 126 selectively supplying hydraulic fluid from the pump 124 to the lift actuator 420. In some embodiments, the lift actuator 420 may be configured to retract, after being extended, toward a retracted position, which corresponds with the lowered position of the cradle 52, the top platform 402, and the scissor assembly 404, via gravity and/or a weight of the cradle 52 and the top platform 402. In some embodiments, the lift actuator 420 may be retracted via one of the valves 126 selectively removing hydraulic fluid from the lift actuator 420 and directing the hydraulic fluid to the tank 122.

In general, the selective extension/retraction of the lift actuator 420 and corresponding raising/lowering of the scissor assembly 404 results in the cradle 52 being selectively raised and lowered relative to the bottom platform 400, the base assembly 48, and the frame 12. It follows that the component (e.g., the axle of the telehandler 56), which is at least partially received within and supported by the cradle 52, may be selectively raised and lowered during the manufacturing line process by the lift assembly 54. In addition to the cradle 52 being selectively raised and lowered by the lift assembly 54, the cradle 52 is rotatably coupled to the top platform 402 to enable steering operation between two of the vehicles 10 during the manufacturing line process.

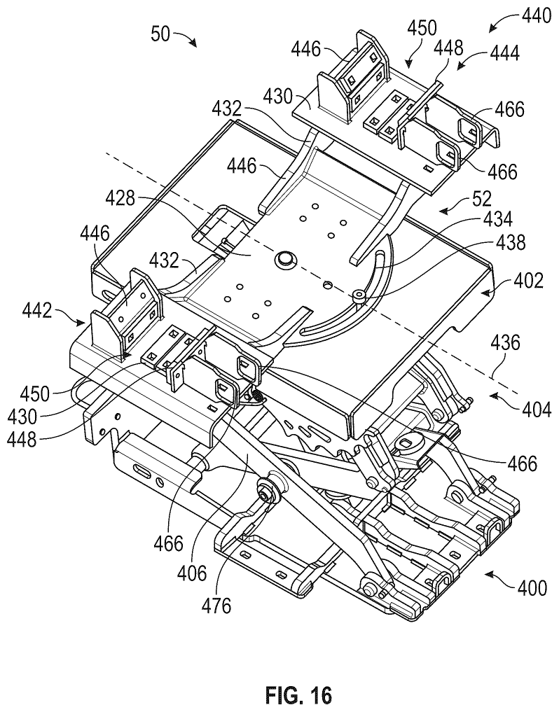

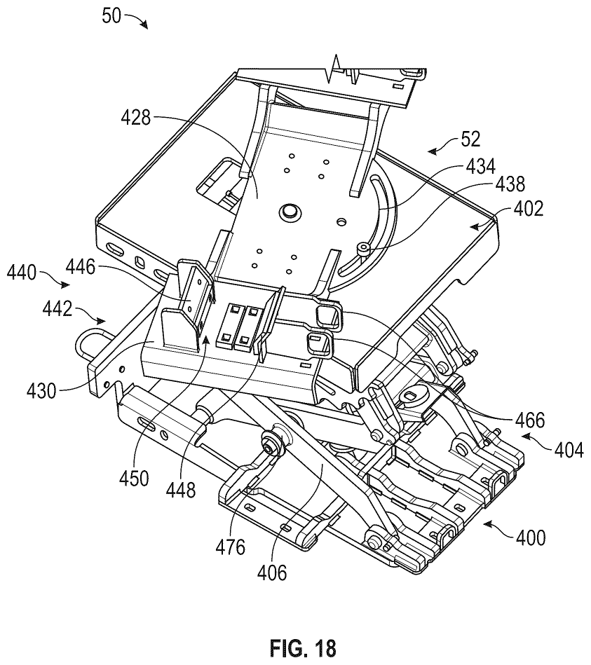

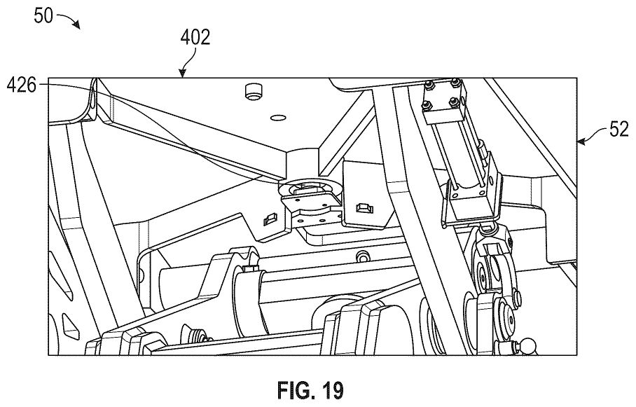

With specific reference to FIGS. 16-19, the cradle 52 is rotatably coupled to the top platform 402 by a cradle pin 426 that is coupled to and extends through the top platform 402 (see, e.g., FIG. 19). The cradle pin 426 extends though the top platform 402 and rotatably couples to the cradle 52, for example, via one or more bearings. In this way, for example, the cradle 52 is allowed to rotate relative to the top platform 402 (and relative to the base assembly 48 and the frame 12), which enables steering operations for the vehicle 10. In some embodiments, the sensors 112 include a rotation sensor (e.g., an encoder) that detects and measures a rotational position of the cradle 52 and communicates the rotational position of the cradle 52 to the controller 102. In some embodiments, the cradle 52 includes a cradle base 428 (e.g., a cradle base plate or base platform) and a pair of bracket plates 430, with one of the bracket plates 430 being coupled to each lateral end of the cradle base 428. The cradle base 428 is supported on a top surface of the top platform 402 and engages with the cradle pin 426. In some embodiments, each of the bracket plates 430 is rigidly coupled or fixed to the cradle base 428 by one or more cradle arms 432 that extend between the cradle base 428 and the respective one of the bracket plates 430.

In general, the cradle 52 includes a rotation slot or rotation limiting channel that defines a rotational range of the cradle 52 relative to the top platform 402 (and the base assembly 48 and the frame 12). In some embodiments, the cradle base 428 includes a rotation slot or arcuate slot 434 that extends through (e.g., vertically) the cradle base 428. The rotation slot 434 extends laterally across a front end of the cradle base 428. The rotation slot 434 extends past or away from both sides of a centerline 436 defined through cradle 52. In this way, for example, the cradle 52 is allowed to rotate in two directions relative to the top platform 402. Specifically, the cradle 52 is allowed to rotate in a first direction (e.g., clockwise) relative to the top platform 402, and in a second direction (e.g., counterclockwise) relative to the top platform 402. As such, the rotational coupling between the cradle 52 and the top platform 402 enables the vehicle 10 to steer in both directions (e.g., right and left).

A pin 438 is received within the rotation slot 434 and protrudes outwardly above the rotation slot 434 (e.g., above a top surface of the cradle base 428). In some embodiments, the pin 438 is in the form of a bolt, a shoulder bolt, or an equivalent structure that extends through the rotation slot 434. In general, the interface between the rotation slot 434 and the pin 438 defines a rotational range or rotational limit for the cradle 52 relative to the top platform 402. For example, the lateral ends of the rotation slot 434 act as end stops for the rotational range of the cradle 52, and as the cradle 52 rotates relative to the top platform 402, the rotation slot 434 moves relative to the pin 438 until the pin 438 engages one of the lateral ends of the rotation slot 434. Once the pin 438 engages one of the lateral ends of the rotation slot 434, the cradle 52 is prevented from rotating relative to the top platform 402 in one direction (e.g., clockwise or counterclockwise). By way of example, if the pin 438 engages a first end of the rotation slot 434 (e.g., a right end from the perspective of FIG. 16), the cradle 52 is prevented from further rotating relative to the top platform 402 in the first direction (e.g., clockwise). And if the pin 438 engages a second end of the rotation slot 434 (e.g., a left end from the perspective of FIG. 16), the cradle 52 is prevented from further rotating relative to the top platform 402 in the second direction (e.g., counterclockwise).

In general, the rotational coupling between the cradle 52 and the top platform 402 enables steering operation for the vehicle 10. As described herein, two of the vehicles 10 may support the telehandler 56 during the manufacturing line process, and the front vehicle may turn relative to the rear vehicle via the drive motors 42 or a steering motor. As the front vehicle turns relative to the rear vehicle, the cradle 52, which supports the telehandler 56, of the front vehicle may rotate relative to the top platform 402 of the front vehicle and allow the two vehicles to turn (e.g., the two vehicles are not restricted to travel in a straight line).

With reference to FIGS. 16-20, the cradle 52 includes a bracket assembly 440 that is configured to at least partially receive and support the axle of the telehandler 56. In some embodiments, the bracket assembly 440 includes a first bracket assembly 442 supported on one of the bracket plates 430 and a second bracket assembly 444 supported on another of the bracket plates 430. In general, the first bracket assembly 442 and the bracket plate 430 it interfaces with include similar components as the second bracket assembly 444 and the bracket plate 430 it interfaces with. It follows that the following description of the first bracket assembly 442 also applies to the second bracket assembly 444, with the same features identified using like reference numerals.

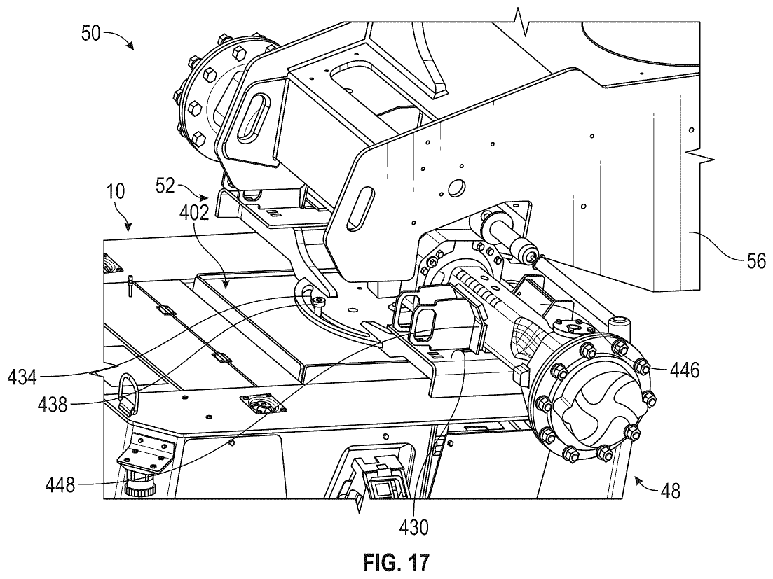

The first bracket assembly 442 includes a fixed bracket 446 and a movable bracket 448. In general, the fixed bracket 446 and the movable bracket 448 define a slot or channel 450 therebetween that is configured to at least partially receive the telehandler 56 (e.g., the axle of the telehandler 56), as shown in FIG. 17. In some embodiments, the channel 450 may define a U shape. In some embodiments, the channel 450 may define a different shape (e.g., V shaped).

The fixed bracket 446 is rigidly coupled to the bracket plate 430 so that the fixed bracket 446 does not move relative to the bracket plate 430. The movable bracket 448 may be selectively moved relative to the fixed bracket 446 (and the bracket plate 430) to adjust a size of the channel 450 defined between the fixed bracket 446 and the movable bracket 448. In some embodiments, the movable bracket 448 is selectively moved by lifting the movable bracket 448 relative to the bracket plate 430 and sliding the movable bracket 448 along an angled feature formed in the bracket plate 430. For example, the bracket plate 430 includes an angled slot 452 that extends through the bracket plate 430 and a plurality of locking slots 454, each of which extends through the bracket plate 430. The angled slot 452 is arranged at an acute angle relative to a first surface 456 of the bracket plate 430 (e.g., an angle greater than zero degrees and less than ninety degrees). In other words, a first end of the angled slot 452 is arranged closer to the first surface 456 than a second end of the angled slot 452, which defines a nonzero or acute angle between the angled slot 452 and the first surface 456. In some embodiments, an angle defined between a center line of the angled slot 452 and the first surface 456 may be between about fifteen degrees and about sixty degrees.

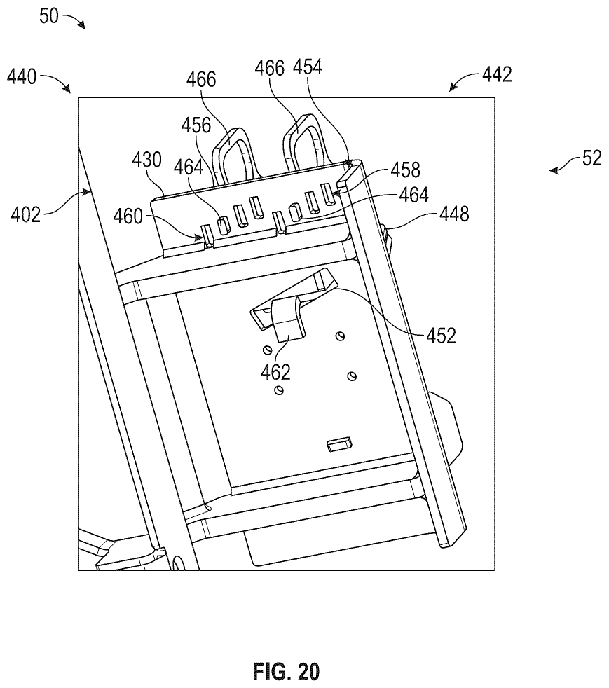

The plurality of locking slots 454 includes a first set of locking slots 458 and a second set of locking slots 460 that are laterally separated (e.g., separated in a direction generally perpendicular to the centerline 436) from the first set of locking slots 458. The first set of locking slots 458 are arranged and oriented in the same pattern as the second set of locking slots 460, except being laterally separated from the second set of locking slots 460. Each of the slots in the first set of locking slots 458 and the second set of locking slots 460 is laterally offset from an adjacent slot and arranged a different distance from the first surface 456 than an adjacent slot. For example, the locking slots on the left side (e.g., from the perspective of FIG. 20) of both the first set of locking slots 458 and the second set of locking slots 460 are arranged a furthest distance from the front surface and the slots to the right of the leftmost slot progressively move closer to the first surface 456.

The movable bracket 448 includes a clip 462, a pair of locking bars 464, and a pair of handles 466. The clip 462 extends through and is at least partially received within the angled slot 452, and the locking bars 464 are each received within a corresponding one of the locking slots in the first set of locking slots 458 and the second set of locking slots 460. To move the movable bracket 448 and adjust a size of the channel 450, a user may grasp the handles 466 of the movable bracket 448 and lift the movable bracket 448 relative to the bracket plate 430. As the handles 466 are lifted, the locking bars 464 are removed from the locking slots 458, which enables the movable bracket 448 to move relative to the fixed bracket 446. Once the locking bars 464 are removed from the locking slots 458, the movable bracket 448 is allowed to move laterally (e.g., left to right, or right to left from the perspective of FIG. 20). As the movable bracket 448 is moved laterally, the engagement between the clip 462 and the angled slot 452 moves the movable bracket 448 longitudinally (e.g., closer to or further from the fixed bracket 446). In other words, the geometry defined by the angled slot 452 allows the movable bracket 448 to move longitudinally as the movable bracket 448 is moved laterally. The movable bracket 448 may be moved both laterally and longitudinally until the locking bars 464 align with another pair of the locking slots 458. Once the locking bars 464 align with a new pair of the locking slots 458, the user may push down on the handles 466 to push the locking bars 464 into the locking slots 458, which locks the position of the movable bracket 448 relative to the fixed bracket 446 and adjusts a size of the channel 450. Accordingly, the movable bracket 448 may be selectively moved so that the locking bars 464 are inserted into a respective pair of the locking slots 458, which corresponds with a particular size of the channel 450. In this way, for example, the bracket assembly 440 is able to accommodate different size axles of the telehandler 56 during the manufacturing line process.

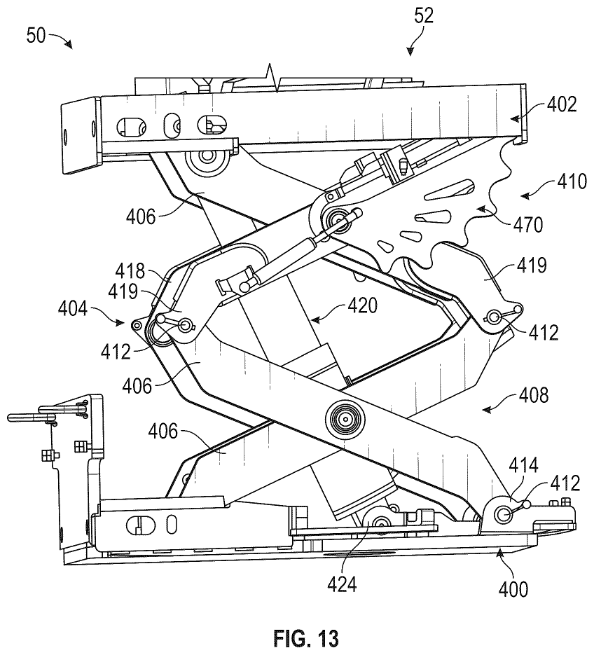

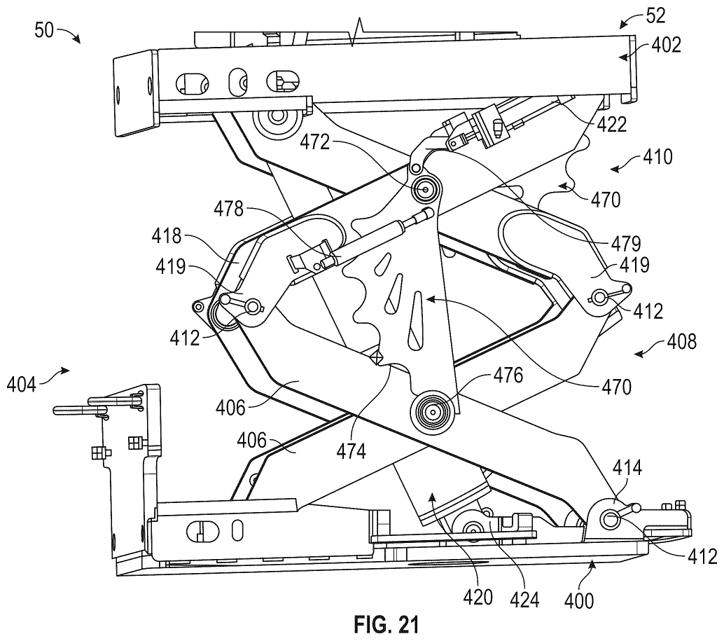

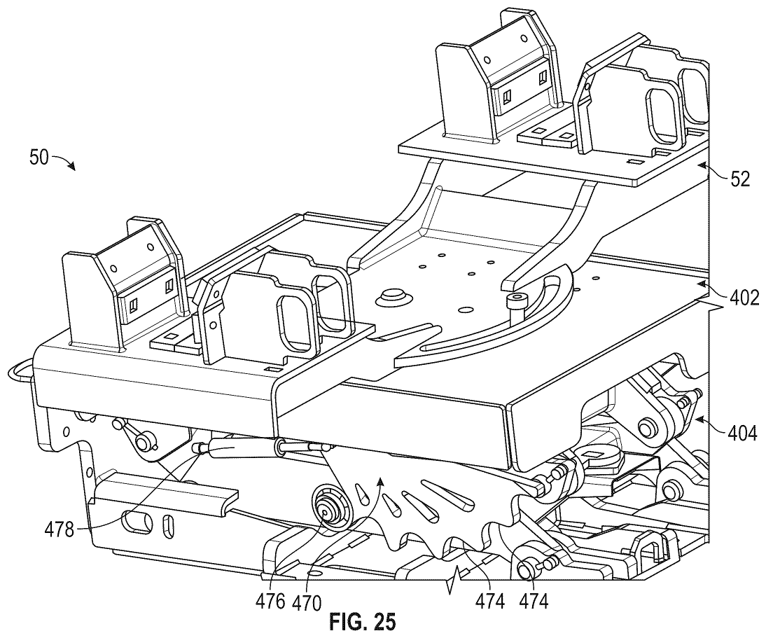

With reference to FIGS. 13, 14, and 21-25, the vehicle 10 includes a support prop or prop wing that is configured to selectively support the scissor assembly 404 in a plurality of raised positions and prevent the scissor assembly 404 (and the cradle 52 and the top platform 402 coupled thereto) from retracting or being lowered. Both lateral sides of the scissor assembly 404 include a support prop 470 pivotably coupled thereto. By placing one of the support props 470 on both lateral sides of the scissor assembly 404, the lateral sway of the scissor assembly 404 is reduced and stability is improved. In general, the design and operation of the support prop 470, and the components of the scissor assembly 404 that interface with the support prop 470, are the same on both lateral sides of the scissor assembly 404. Accordingly, the description herein of one of the support props 470 on one side of the scissor assembly 404 also applies equally to the support prop 470 on the other side of the scissor assembly 404, with similar components identified using the same reference numerals.

The support props 470 are each pivotably coupled to a side of the scissor assembly 404 by a pivot pin 472. In some embodiments, a centerline or center axis defined through the pivot pin 472 defines a pivot axis for the support prop 470. In some embodiments, the pivot pin 472 may be coupled to the scissor assembly 404 at a junction between two of the lift arms 406 in the upper section 410 (e.g., a center of the x-shaped crisscross between the two lift arms 406). The support props 470 include a plurality of notches or recesses 474 that are sequentially arranged along an outer edge or side of the support prop 470. In some embodiments, the notches 474 each define a generally rounded indent that extends inwardly into the outer edge of the support prop 470. In some embodiments, the notches 474 may define a different shape, for example, rectangular, triangular, or another polygonal shape.

In general, at least one of the notches 474 on both of the support props 470 are configured to engage a prop pin 476 that extends outwardly from a side of the scissor assembly 404. For example, one of the prop pins 476 extends outwardly from each side of the scissor assembly 404. The prop pins 476 are arranged generally below the pivot pins 472. For example, the prop pins 476 may be coupled to the scissor assembly 404 at a junction between two of the lift arms 406 in the lower section 408 (e.g., a center of the x-shaped crisscross between the two lift arms 406).

The support props 470 are both pivotably biased by a spring 478 coupled between the respective support prop 470 and the scissor assembly 404. For example, each of the springs 478 is coupled between an outer side of the support prop 470 and an outer side of the scissor assembly 404. Specifically, the springs 478 are coupled to one of the outer intermediate brackets 419 and the support prop 470. In some embodiments, the springs 478 may be in the form of a gas spring. In some embodiments, the springs 478 may both act in compression so that the springs 478 pivotably bias the support props 470 in a first direction (e.g., so that the notches 474 are rotationally biased toward the prop pins 476).

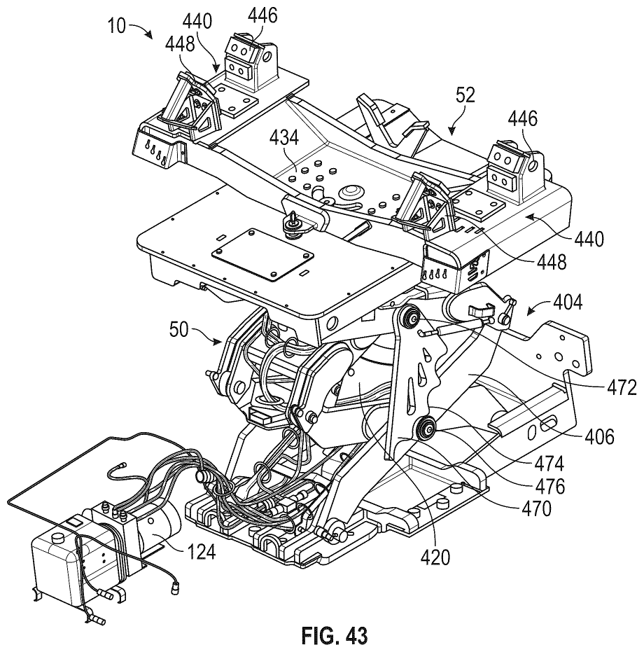

The support props 470 are both pivotably coupled to a respective one of the prop actuators 422. The prop actuators 422 are configured to selectively pivot the support props 470 in a second direction opposite to bias of the spring 478. For example, each of the prop actuators 422 are coupled to the support props 470 by a linkage 479 so that extension of the prop actuators 422 results in the linkage 479 pivoting the support props 470 away from the prop pins 476. In some embodiments, the prop actuators 422 are hydraulically operated and are configured to extend via one or more of the valves 126 selectively supplying hydraulic fluid from the pump 124 to the prop actuators 422 (see, e.g., FIG. 43). In some embodiments, one or more valves 126 that control fluid flow to and/or from the prop actuators 422 may connect the prop actuators 422 to the tank 122, unless the prop actuators 422 are commanded to pivot the support props 470 away from the prop pins 476, so that the springs 478 are allowed to pivotably bias the notches 474 toward and into engagement with the prop pins 476 as the scissor assembly 404 is raised.

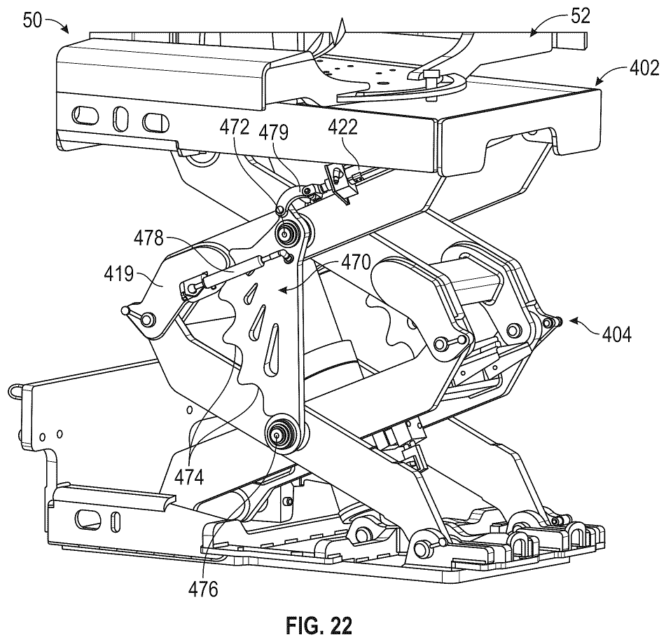

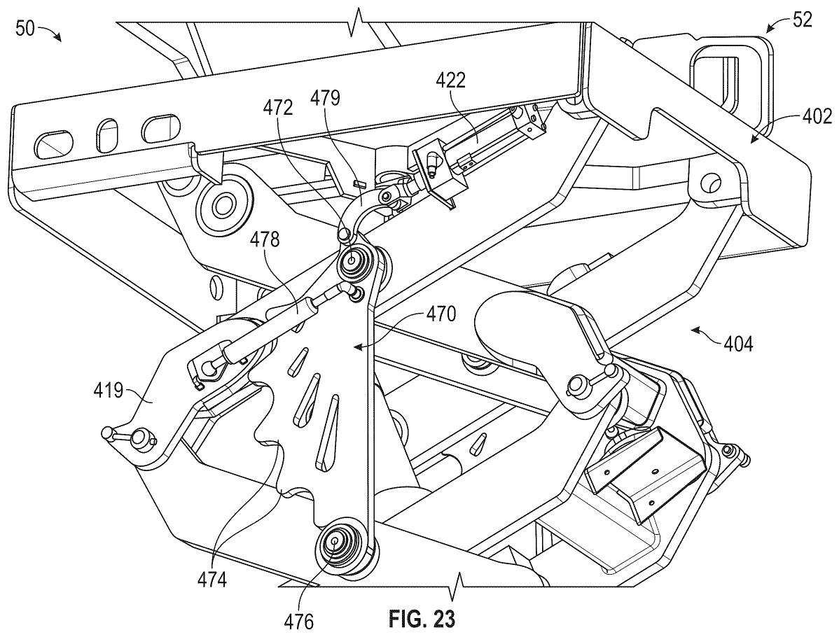

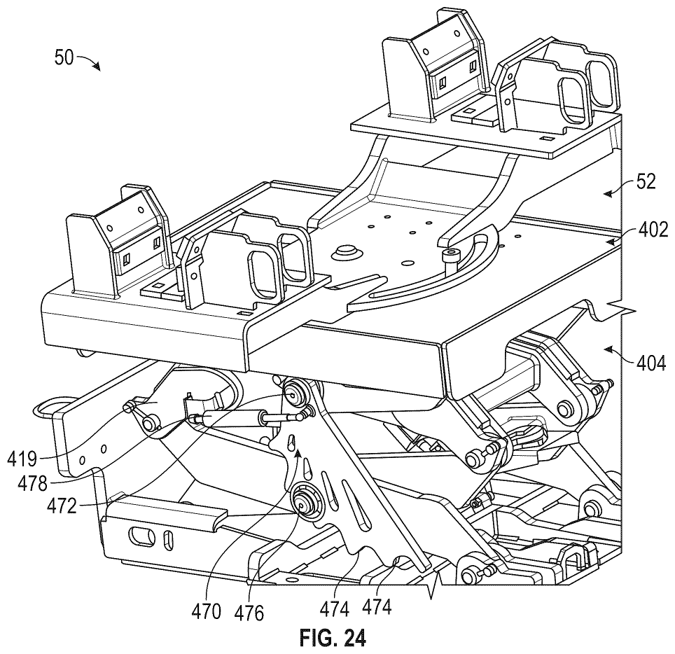

During operation, as the scissor assembly 404, the top platform 402, and the cradle 52 are raised by the lift actuator 420, the springs 478 pivotably bias the support props 470 in the first direction, which ensures that the notches 474 sequentially engage the prop pins 476 (e.g., like a rachet mechanism). In this way, for example, as the scissor assembly 404 is raised, the support props 470 always align and ensure engagement between at least one of the notches 474 with the prop pins 476 (e.g., at an intermediate position as shown in FIG. 24, at the raised position as shown in FIGS. 22 and 23, or any other position between the lowered position and the raised position). The engagement between the notches 474 on the support props 470 and the prop pins 476 (e.g., a locked position) prevents the scissor assembly 404, the top platform 402, and the cradle 52 from being lowered and prevents unintentional lowering of the scissor assembly 404, for example, in the event of a hydraulic or power failure.

To lower the scissor assembly 404, the top platform 402, and the cradle 52 from a position above the lowered position (e.g., any position between the lowered position and the raised position), the support props 470 are pivoted away from the prop pins 476 so that the scissor assembly 404 is allowed to freely retract toward the base assembly 48. For example, the prop actuators 422 are configured to selectively actuate or extend, which applies a pivotal force on the support props 470 via the linkages 479. The pivotal force applied by the prop actuators 422 counteracts (e.g., opposes) and overcomes the pivotal force of the springs 478, and the support props 470 pivot away from the prop pins 476 (e.g., in a direction toward the top platform 402 as shown in FIGS. 13, 14, and 25). With the support props 470 pivoted away from the prop pins 476 so that the notches 474 do not engage the prop pins 476 (e.g., an unlocked position), the scissor assembly 404, the top platform 402, and the cradle 52 are allowed to be lowered toward the base assembly 48 (e.g., via gravity and/or a weight of/supported on the top platform 402).

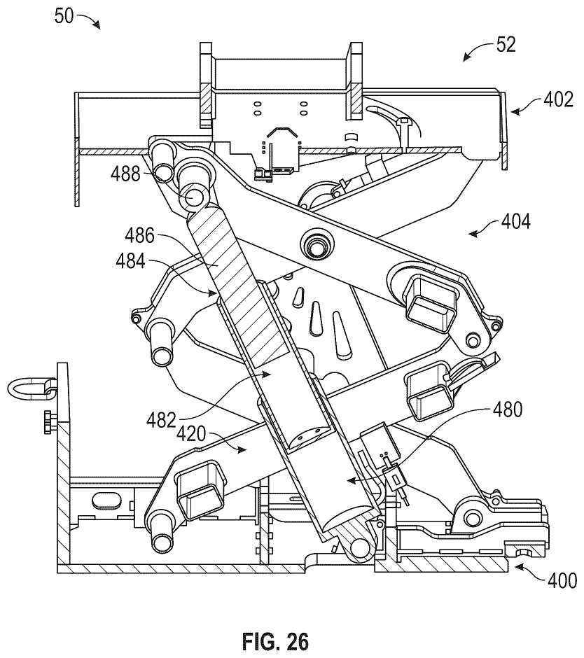

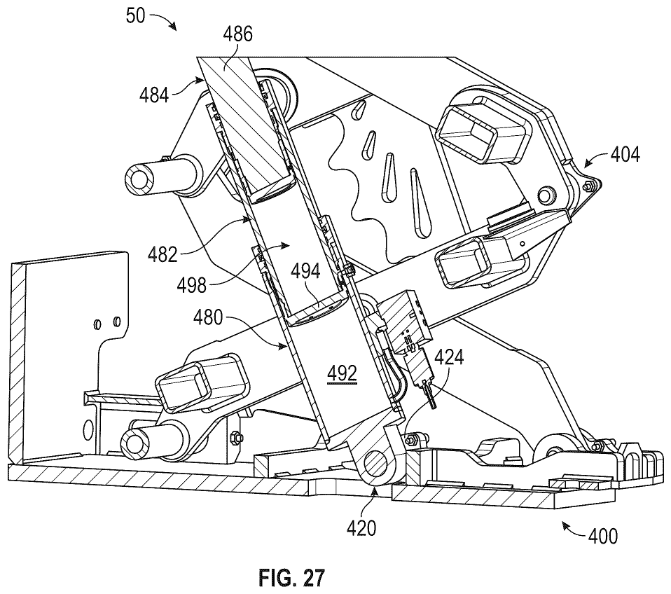

With reference to FIGS. 26-32, the lift actuator 420 is in the form of a multi-stage telescoping actuator that includes a base stage 480, an intermediate or middle stage 482, and an end or outer stage 484. The base stage 480 is pivotably coupled to the bottom platform 400 via a pin extending through the actuator bracket 424. The middle stage 482 is arranged axially between the base stage 480 and the outer stage 484. The outer stage 484 includes an actuator rod 486 that is slidably received within the middle stage 482. The middle stage 482 defines a cylinder that is slidable received within the base stage 480, which also defines a cylinder. A distal end of the outer stage 484 is pivotably coupled to a coupling rod 488, which is coupled to the scissor assembly 404 (e.g., extends between a pair of lift arms 406 in the upper section 410).

As described herein, the lift actuator 420 is configured to selectively raise the scissor assembly 404, the top platform 402, and the cradle 52. For example, one or more of the valves 126 may selectively supply pressurized hydraulic fluid from the pump 124 to a port 490 that extends through an outer wall of the base stage 480. The port 490 is in fluid communication with a base chamber 492 defined between the base stage 480 and the middle stage 482. As the pressurized hydraulic fluid enters the base chamber 492, the base chamber 492 expands and the middle stage 482 and the outer stage 484 (and the actuator rod 486) extend relative to the base stage 480.

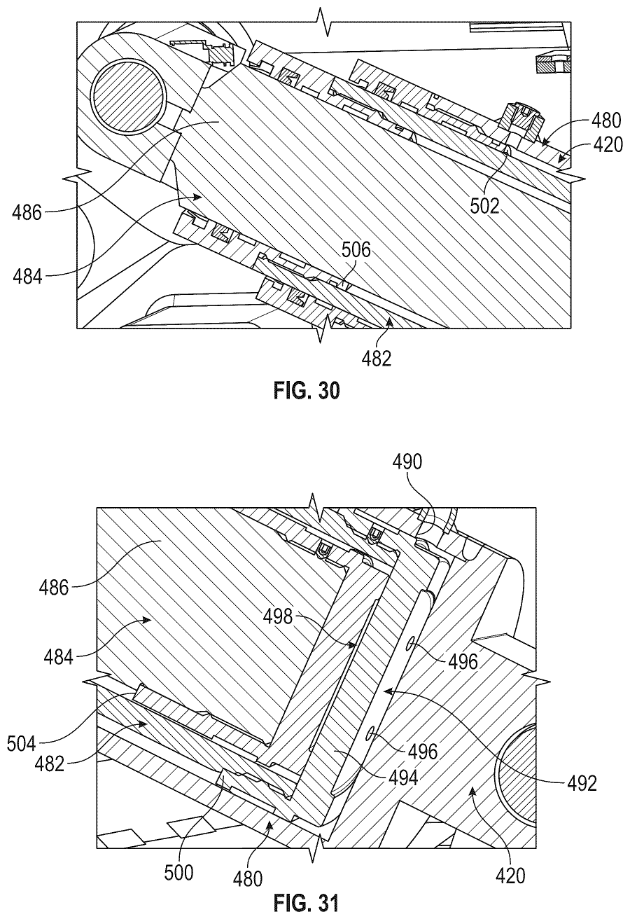

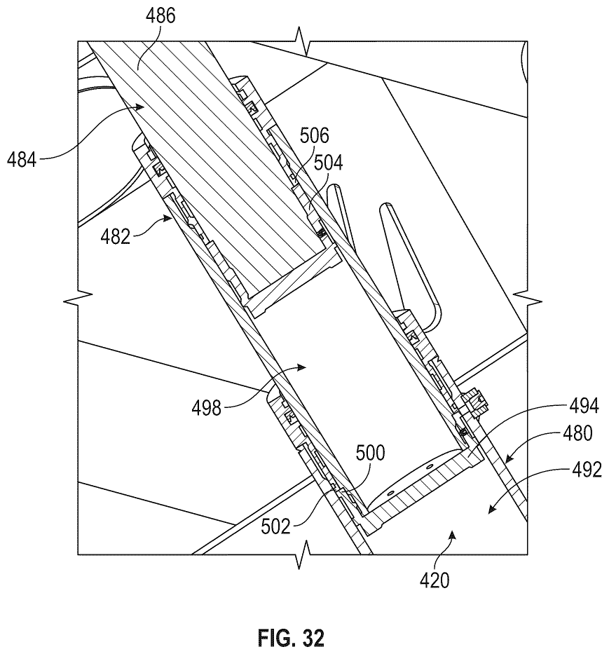

A bottom wall 494 of the middle stage 482 includes one or more holes 496 (see, e.g., FIG. 31) that provide fluid communication between the base chamber 492 and a middle chamber 498 defined between the middle stage 482 and the outer stage 484. The middle stage 482 is allowed to extend relative to the base stage 480 until a stop flange 500, formed in a base of the middle stage 482, engages a base collar 502 coupled to a distal end of the base stage 480 (e.g., an end opposite from the bottom platform 400). The base collar 502 is arranged radially between an inner wall of the base stage 480 and an outer wall of the middle stage 482 (see, e.g., FIG. 30). As the middle stage 482 extends relative to the base stage 480, the stop flange 500 comes closer and closer to the base collar 502, until the stop flange 500 eventually engages the base collar 502 and prevents the middle stage 482 and the actuator rod 486 from further extending relative to the base stage 480 (see, e.g., FIG. 32).

Once the middle stage 482 is no longer able to extend relative to the base stage 480, the holes 496 formed in the middle stage 482 provide the pressurized hydraulic fluid to the middle chamber 498, which then expands and extends the outer stage 484 and the actuator rod 486 relative to the middle stage 482 and the base stage 480. Similar to the middle stage 482, the actuator rod 486 is allowed to extend relative to the middle stage 482 until a stop flange 504, formed in a base of the actuator rod 486, engages a middle collar 506 coupled to a distal end of the middle stage 482 (e.g., an end furthest away from the base stage 480). The middle collar 506 is arranged radially between an inner wall of the middle stage 482 and an outer wall of the actuator rod 486 (see, e.g., FIG. 30). As the actuator rod 486 extends relative to the middle stage 482, the stop flange 504 comes closer and closer to the middle collar 506, until the stop flange 504 eventually engages the middle collar 506 and prevents the actuator rod 486 from further extending relative to the middle stage 482 (see, e.g., FIG. 32). In some embodiments, when both the stop flange 500 engages the base collar 502 and the stop flange 504 engages the middle collar 506, the lift actuator 420 is fully extended and the scissor assembly 404, the top platform 402, and the cradle 52 are in the fully raised position.

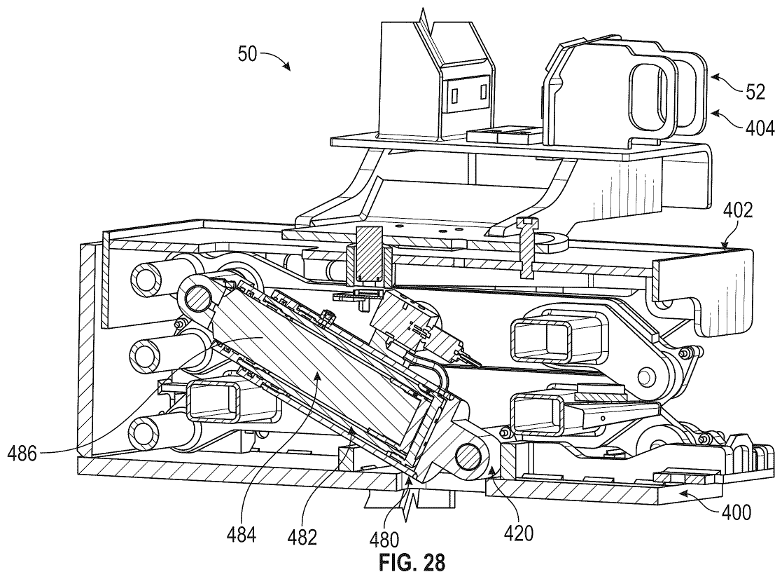

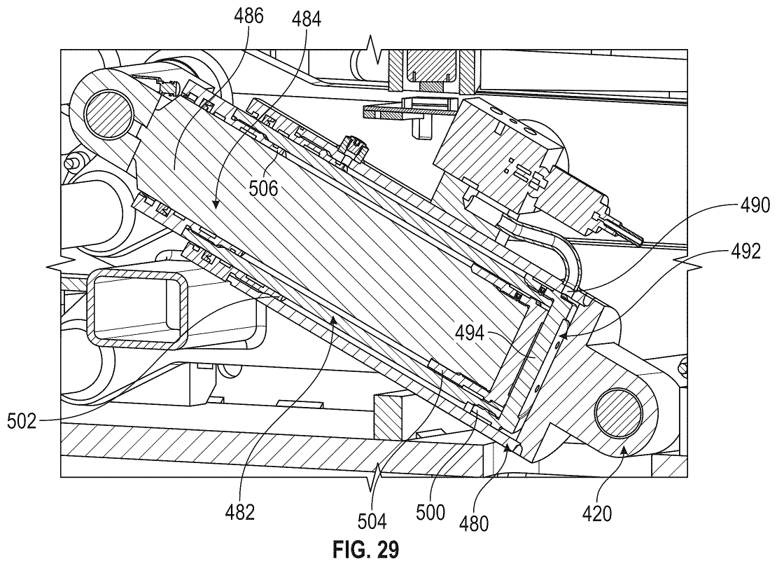

In some embodiments, the one or more valves 126 are configured to connect the port 490 to the tank 122 and allow the actuator rod 486 to telescopically retract into the middle stage 482 and the base stage 480 via gravity and/or the weight of the top platform 402 acting on the actuator rod 486. The use of a multi-stage actuator as the lift actuator 420 facilitates a compact arrangement, for example, when the lift actuator 420 is retracted (see, e.g., FIGS. 28 and 29), because the axial length of the lift actuator 420 is reduced by incorporating multiple stages, rather than using a single stage actuator that requires the entire stroke be accommodated by a single cylinder.

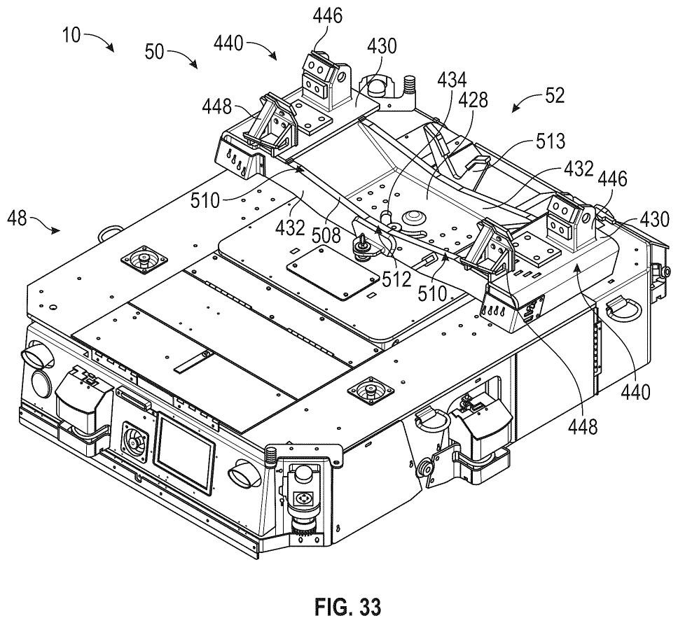

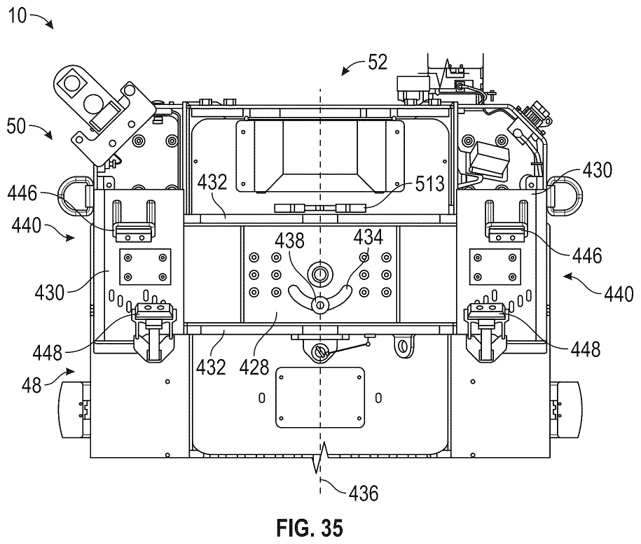

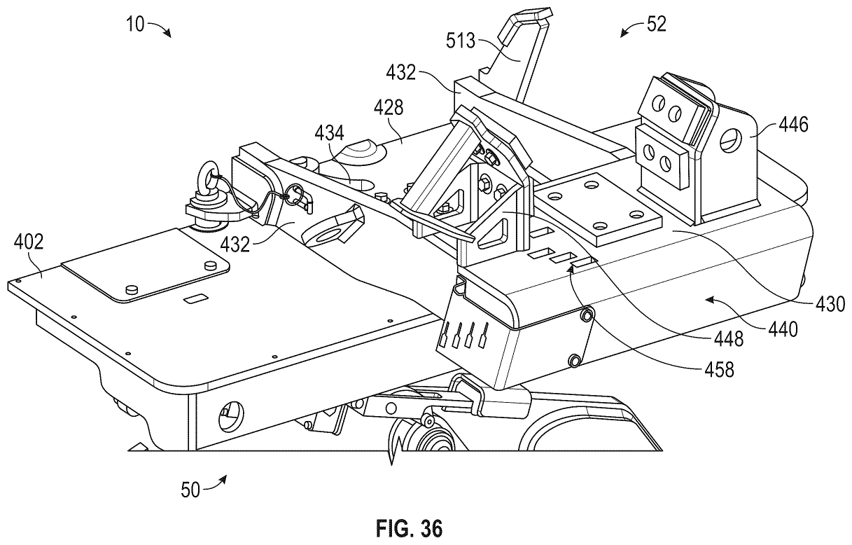

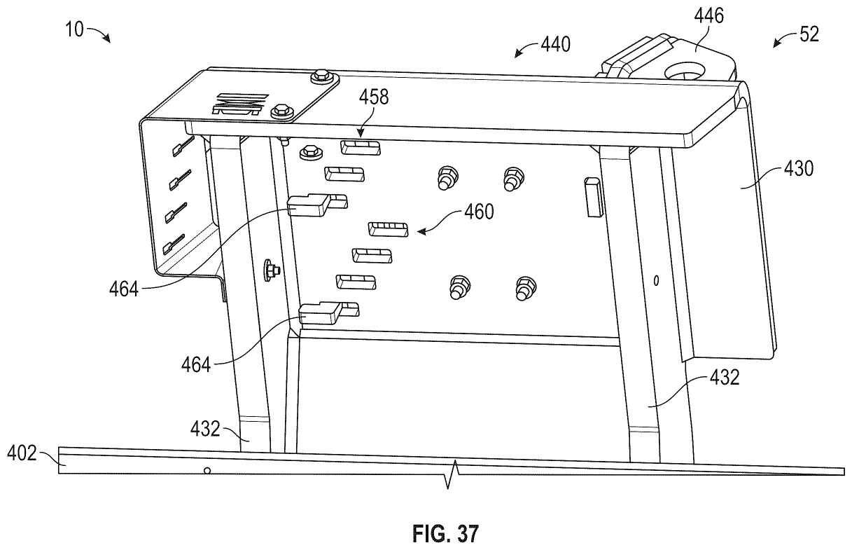

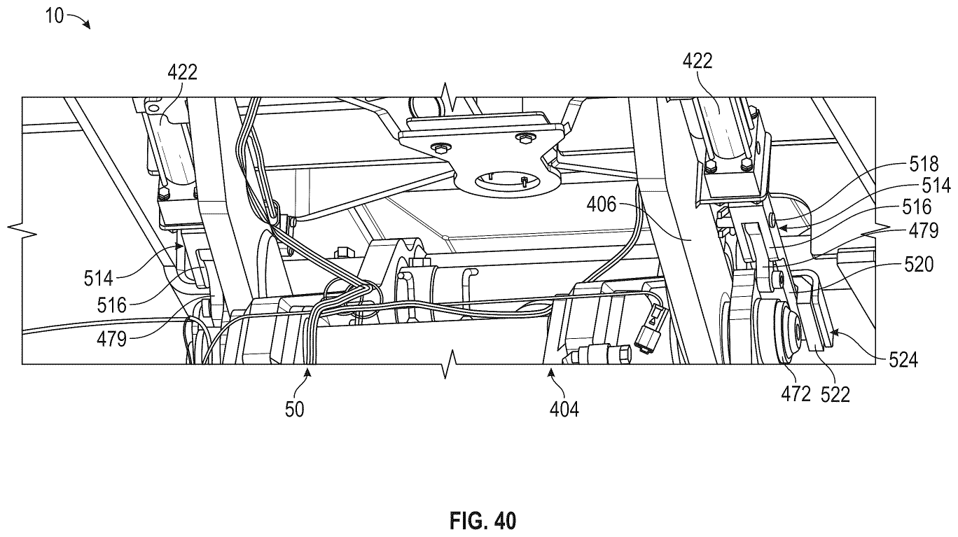

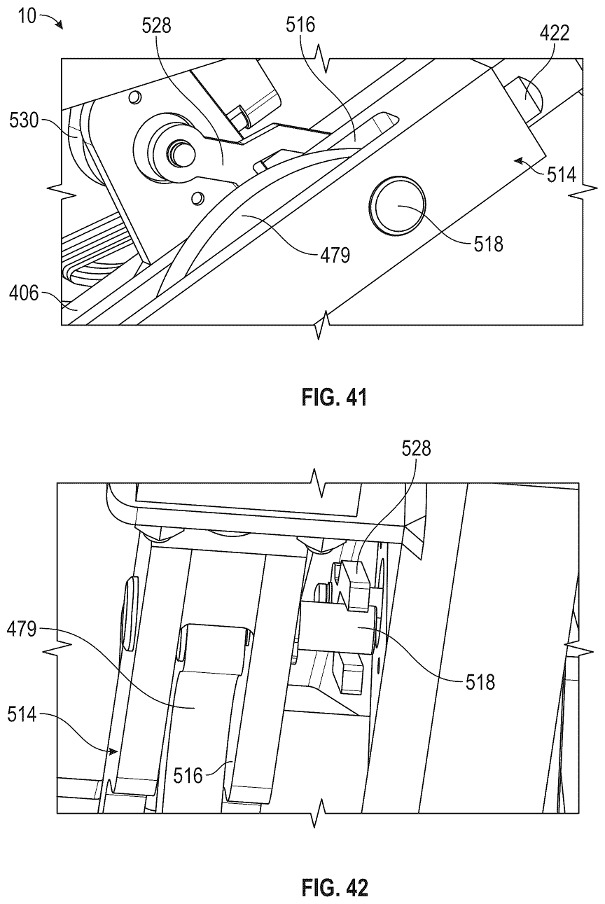

FIGS. 33-43 illustrate an exemplary embodiment of the vehicle 10 including the lifting implement 50. In general, the lifting implement 50 of FIGS. 33-43 is similar in design and functionality as the lifting implement 50 of FIGS. 9-32, with like features identified using the same reference numerals, except as described herein or as apparent from the figures. With specific reference to FIGS. 33-35, the cradle arms 432 extend laterally across and entirety of the cradle base 428. For example, each of the cradle arms 432 extends from one of the bracket plates 430, across the cradle base 428, and to the opposing one of the bracket plates 430. Additionally, each of the cradle arms 432 defines a generally V-shaped profile as it extends laterally between the bracket plates 430. Specifically, a top surface 508 of each of the cradle arms 432 defines a V-shaped profile, with two angled portions 510 (e.g., taper toward the cradle base 428) and a generally flat portion 512 (e.g., generally parallel to the cradle base 428) arranged between the two angled portions 510. The V-shaped profile defined by the cradle arms 432 aids in securing and supporting a center of the axle of the telehandler 56.

The cradle 52 includes an axle support bracket 513 coupled to an outer surface of one of the one or more cradle arms 432 (see, e.g., FIG. 33). In the illustrated embodiment, the axle support bracket 513 is coupled to a rearmost one of the cradle arms 432 and further aids in securing and supporting a center of the axle of the telehandler 56.

In the illustrated embodiment, the rotation slot 434 defines an arcuate shape, similar to FIGS. 9-32, but extends a lateral distance that is less than the rotation slot 434 shown in FIGS. 9-32. In other words, the rotation slot 434 of FIGS. 33-35 defines a greater radius than the rotation slot 434 of FIGS. 9-32, but still allows a similar rotational range for the cradle 52. In the illustrated embodiment, the support props 470 include four of the notches 474 (see, e.g., FIG. 43), while the support props 470 of FIGS. 9-32 include five notches 474. The number of the notches 474 on the support props 470 may be changed depending on the particular application and height range defined by the lifting implement 50.

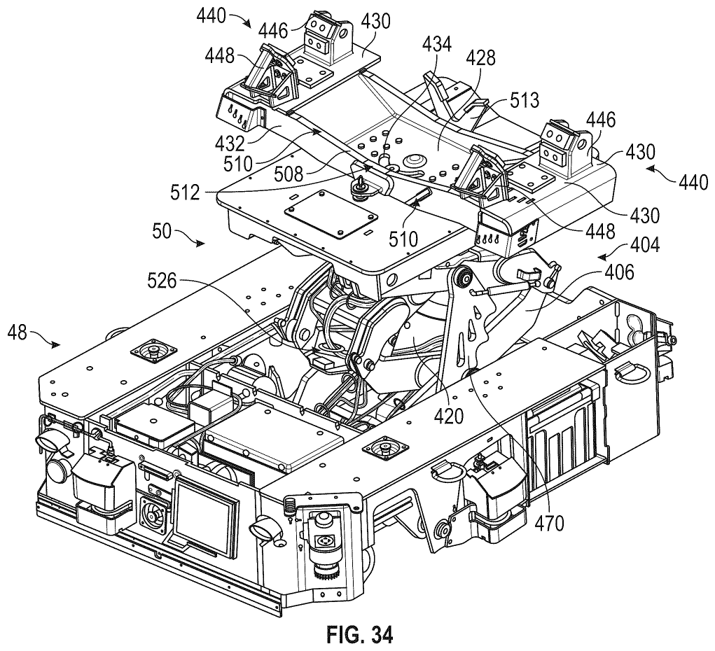

Turning to FIGS. 34-37, the bracket assembly 440 includes the fixed bracket 446 and the movable bracket 448 within each of the first bracket assembly 442 and the second bracket assembly 444. The functionality of the movable bracket 448 remains similar to that described herein, except the functionality of the clip 462 and the locking bars 464 is integrated into a single component. For example, the angled slot 452 and the clip 462 are removed from the bracket assembly 440 and the locking bars 464 are designed to be L-shaped, which enables the locking bars 464 to hook on an edge of the first set of locking slots 458 and the second set of locking slots 460 (e.g., similar to how the clip 462 hooks on the angled slot 452).

To adjust a spacing or gap between the fixed bracket 446 and the movable bracket 448, the movable bracket 448 is moved toward the fixed bracket 446, which moves the L-shaped locking bars 464 into a position where they can be removed through the first set of locking slots 458 and the second set of locking slots 460. The movable bracket 448 is then pulled up to remove the locking bars 464 from the current pair of the first set of locking slots 458 and the second set of locking slots 460 and moved (e.g., diagonally and closer to or further away from the fixed bracket 446) to align the locking bars 464 with another pair of the first set of locking slots 458 and the second set of locking slots 460, which are at a different longitudinal location along the bracket plate 430. The movable bracket 448 is then moved downwardly toward the bracket plate 430 so that the locking bars 464 are inserted into the pair of the first set of locking slots 458 and the second set of locking slots 460. With the locking bars 464 within the pair of the first set of locking slots 458 and the second set of locking slots 460, the movable bracket 448 is then moved in a direction away from the fixed bracket 446, which hooks the locking bars 464 on an edge of the pair of first set of locking slots 458 and the second set of locking slots 460, which aids in preventing the movable bracket 448 from being removed from the first set of locking slots 458 and the second set of locking slots 460 (e.g., without moving it toward the fixed bracket 446). Accordingly, the movable bracket 448 is selectively movable to any corresponding pair of the first set of locking slots 458 and the second set of locking slots 460 to adjust the distance between the fixed bracket 446 and the movable bracket 448.

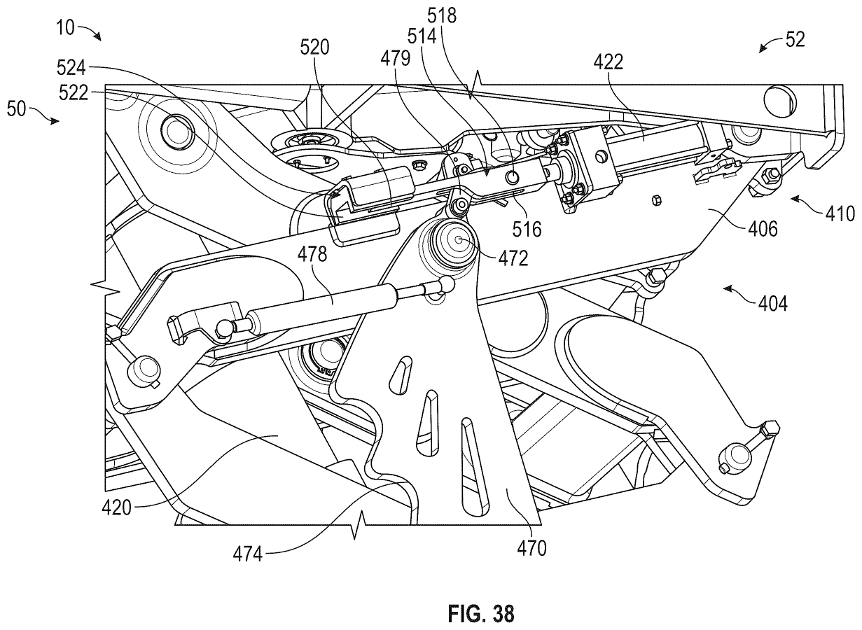

Turning to FIGS. 38-40, each of the prop actuators 422 is coupled to a support bracket 514 that provides lateral stability to the prop actuators 422 and the scissor assembly 404 (e.g., stability in a direction generally perpendicular to the centerline 436). The support brackets 514 each include a channel or slot 516 that receives at least a portion of the linkage 479 therein. A distal end of the linkage 479 is coupled to the support props 470, as in the exemplary embodiment of FIGS. 9-32, but the coupling between the prop actuator 422 and the linkage 479 is arranged within the support bracket 514. Specifically, a pin 518 extends through the support bracket 514, the linkage 479, and a rod of the prop actuator 422 to couple the prop actuator 422, the linkage 479, and the support bracket 514 to one another.

Each of the support brackets 514 includes a support bar 520 extending outwardly (e.g., in a direction away from the pin 518) from an end of the slot 516. Each of the support bars 520 is received within a support channel 522 that is formed in a support block 524. The support blocks 524 are coupled to a respective one of the lift arms 406 (e.g., the same one of the lift arms 406 in the upper section 410 that the prop actuator 422 is coupled to), and the support channel 522 slidably receives at least a portion of the support bar 520 therein. During operation, as the prop actuators 422 extend and retract to selectively pivot the support props 470, the support bracket 514, which are coupled to the prop actuators 422 via the pins 518, also extend and retract, and the support bars 520 slide or move within a respective one of the support channels 522. At least a portion of the support bar 520 remains in engagement with the support channel 522 over the entire stroke of the prop actuator 422, and the engagement between the support bar 520 and the support channel 522 provides lateral stability to the prop actuators 422 and the scissor assembly 404 during operation. In other words, with the support channel 522 and the support block 524 being rigidly coupled to one of the lift arms 406, the coupling between the support bracket 514, the prop actuators 422, and the linkage 479 acts to laterally hold or constrain the prop actuators 422, the linkage 479, and the scissor assembly 404 (e.g., inhibits or constrains lateral movement) during operation.

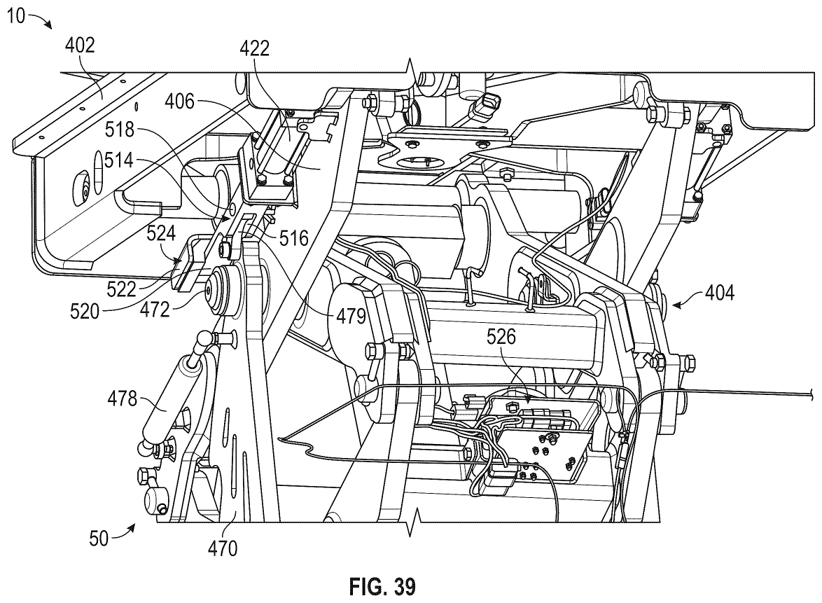

With specific reference to FIG. 39, the scissor assembly 404 includes an inertial measurement unit, show an IMU 526. The IMU 526 is included in the sensors 112 and is in communication with the controller 102. The IMU 526 is pivotably coupled to the scissor assembly 404 so that an angular position of the IMU 526 changes as the scissor assembly 404 moves, via the lift actuator 420, between the lowered position and the raised position. The angular position of the IMU 526 is correlated to the position or height of the cradle 52, the top platform 402, and the scissor assembly 404. In this way, for example, the controller 102 is configured to determine a height of the cradle 52, the top platform 402, and the scissor assembly 404 based on the angular position of the IMU 526.

Turning to FIGS. 38-42, each of the pins 518 is coupled to a prop position arm 528 that rotates in response to actuation of the support props 470 via the prop actuators 422. Each of the pins 518 extend through a corresponding one of the support brackets 514 so that a distal end of the pin 518 protrudes outwardly from the support bracket 514. Each of the prop position arms 528 engages the distal end of a corresponding one of the pins 518, so that the prop position arm 528 rotatably coupled to the pin 518 (e.g., rotation of the pin 518 results in the same magnitude of rotation of the prop position arm 528). In the illustrated embodiment, the prop position arms 528 define a generally fork-like shape, with two separated fork arms that define a slot or channel therebetween that receives the pin 518. Accordingly, the prop position arm 528 engages two opposing sides of the pin 518 so that movement of the pin 518, via actuation (e.g., extension or retraction) of the prop actuator 422, results in rotation of the prop position arm 528. The actuation direction of the prop actuator 422 is therefore correlated to a rotation direction of the prop position arm 528. With the pin 518 being coupled to both the prop position arm 528 and the support props 470, the rotational position of the prop position arm 528 is correlated to the rotational position of the support props 470.

In an exemplary embodiment, each of the prop position arms 528 is coupled to an encoder or a rotary position sensor 530 that measures a rotational position of the prop position arms 528. The rotary position sensor 530 is included in the sensors 112 and is in communication with the controller 102. The controller 102 is configured to determine a rotational position of the support props 470 based on the rotational position of the prop position arms 528 measured by the rotary position sensor 530. For example, actuation (e.g., extension) of the prop actuators 422 in a first translational direction moves the pins 518 in the along the first translation direction and pivots both the support props 470 and the prop position arms 528 to a particular rotational position (e.g., the support props 470 rotate in a first rotational direction). The distance that the pins 518 travel along the first translation direction is directly correlated to the rotational position of the prop position arms 528 and the support props 470. Similarly, actuation (e.g., retraction) of the prop actuators 422 in a second translational direction (e.g., opposite to the first translational direction) moves the pins 518 in the along the second translation direction and pivots both the support props 470 and the prop position arms 528 to a particular rotational position (e.g., the support props 470 rotate in a second rotational direction opposite to the first rotational direction). The distance that the pins 518 travel along the second translation direction is directly correlated to the rotational position of the prop position arms 528 and the support props 470. As such, the rotary position sensor 530 is configured to output a signal to the controller 102 that indicates a position of the support props 470 and provides an indication of whether the notches 474 are in engagement with the prop pins 476, or the notches 474 are pivoted away from the prop pins 476.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the production system as shown in the various exemplary embodiments is illustrative only. Additionally, any element disclosed in one embodiment may be incorporated or utilized with any other embodiment disclosed herein.

What is claimed is:

1. A vehicle, comprising:
a frame;
a drivetrain coupled to the frame and including a drive motor configured to propel a tractive element;
a base assembly coupled to the frame; and
a lifting implement coupled to and supported on the base assembly, the lifting implement including:
a platform;
a cradle rotatably coupled to and supported on the platform;
a scissor assembly coupled between the platform and the base assembly; and
a lift actuator coupled between the base assembly and the scissor assembly so that the lift actuator is configured to selectively raise the cradle relative to the base assembly, wherein the lift actuator is a multi-stage telescoping actuator that includes a base stage, an intermediate stage, and an outer stage, and wherein the base stage is coupled to the base assembly, the outer stage is coupled to the scissor assembly, and the intermediate stage is arranged between the base stage and the outer stage.

2. The vehicle of claim 1, wherein the scissor assembly includes a plurality of lift arms that are pivotally coupled to one another.

3. The vehicle of claim 2, wherein the outer stage of the lift actuator is coupled to a pair of the plurality of lift arms that are coupled to the platform.

4. The vehicle of claim 3, wherein the outer stage includes an actuator rod that is coupled to a coupling rod, wherein the coupling rod is coupled between the pair of the plurality of lift arms.

5. The vehicle of claim 1, wherein a port is formed in an outer wall of the base stage, and wherein the port is in fluid communication with a base chamber defined between the base stage and the intermediate stage.

6. The vehicle of claim 5, wherein a bottom wall of the intermediate stage includes a hole that provides fluid communication between the base chamber and an intermediate chamber formed within the intermediate stage.

7. The vehicle of claim 1, wherein the intermediate section includes a stop flange, and the base stage includes a base collar, and wherein engagement between the base collar and the stop flange is configured to limit extension of the intermediate stage relative to the base stage.

8. The vehicle of claim 7, wherein outer stage includes an actuator rod having an actuator stop flange and the intermediate section includes an intermediate collar, and wherein engagement between the actuator stop flange and the intermediate collar is configured to limit extension of the actuator rod relative to the intermediate stage.

9. The vehicle of claim 1, wherein the cradle includes an arcuate slot and a pin received within the arcuate slot.

10. The vehicle of claim 9, wherein engagement between the pin and distal ends of the arcuate slot is configured to limit rotation of the cradle relative to the platform.

11. The vehicle of claim 1, wherein the cradle includes a bracket assembly that is supported on a bracket plate, and wherein the bracket assembly includes a fixed bracket and a movable bracket.

12. The vehicle of claim 11, wherein a channel or slot is defined between the fixed bracket and the movable bracket, and wherein a size of the channel or slot is selectively adjustable by lifting the movable bracket relative to the bracket plate and sliding the movable bracket to align a locking bar of the movable bracket with one of a plurality of locking slots formed in the bracket plate.

13. A vehicle, comprising:
a frame;
a drivetrain coupled to the frame and including a drive motor configured to propel a tractive element;
a base assembly coupled to the frame; and
a lifting implement coupled to and supported on the base assembly, the lifting implement includes:
a platform;
a cradle rotatably coupled to and supported on the platform, wherein the cradle includes an arcuate slot and a pin received within the arcuate slot, and wherein engagement between the pin and distal ends of the arcuate slot is configured to limit rotation of the cradle relative to the platform;
a scissor assembly coupled between the platform and the base assembly; and
a lift actuator coupled between the base assembly and the scissor assembly, wherein the lift actuator is configured to selectively raise the cradle relative to the base assembly.

14. The vehicle of claim 13, wherein the lift actuator is a multi-stage telescoping actuator that includes a base stage, an intermediate stage, and an outer stage.

15. The vehicle of claim 13, wherein the cradle includes a bracket assembly that is supported on a bracket plate, and wherein the bracket assembly includes a fixed bracket and a movable bracket.

16. The vehicle of claim 15, wherein a channel or slot is defined between the fixed bracket and the movable bracket, and wherein a size of the channel or slot is selectively adjustable by lifting the movable bracket relative to the bracket plate and sliding the movable bracket to align a locking bar of the movable bracket with one of a plurality of locking slots formed in the bracket plate.

17. A vehicle, comprising:
a frame;
a drivetrain coupled to the frame and including a drive motor configured to propel a tractive element;
a base assembly coupled to the frame; and
a lifting implement coupled to and supported on the base assembly, the lifting implement includes:
a platform;
a cradle rotatably coupled to and supported on the platform, wherein the cradle includes a bracket assembly that is supported on a bracket plate, wherein the bracket assembly includes a fixed bracket and a movable bracket, wherein a channel or slot is defined between the fixed bracket and the movable bracket, and wherein a size of the channel or slot is selectively adjustable by lifting the movable bracket relative to the bracket plate to align a locking bar of the movable bracket with one of a plurality of locking slots formed in the bracket plate;
a scissor assembly coupled between the platform and the base assembly; and
a lift actuator coupled between the base assembly and the scissor assembly, wherein the lift actuator is configured to selectively raise the cradle relative to the base assembly.

18. The vehicle of claim 17, wherein the locking bar is L-shaped.

19. The vehicle of claim 18, wherein each of the plurality of locking slots is arranged a different distance from a first surface of the bracket plate.

20. The vehicle of claim 17, wherein the lift actuator is a multi-stage telescoping actuator that includes a base stage, an intermediate stage, and an outer stage.
